(19) United States
(12) Patent Application Publication
(10) Pub. No.: US 2025/0386925 A1
(43) Pub. Date: Dec. 25, 2025

(54) POWER TOOL FOR CLEANING

(71) Applicant: Nanjing Chervon Industry Co., Ltd., Nanjing (CN)

(72) Inventors: Mingtan Fu, Nanjing (CN); Lisong Zhang, Nanjing (CN)

(21) Appl. No.: 19/312,655

(22) Filed: Aug. 28, 2025

Related U.S. Application Data
(63) Continuation of application No. PCT/CN2024/080221, filed on Mar. 6, 2024.

(30) Foreign Application Priority Data
Mar. 16, 2023 (CN) 202310257460.1

(51) Int. Cl. A46B 13/02; A46B 5/00; A46B 9/02; A46B 13/00; B25G 1/04; B25G 3/38

(52) U.S. Cl. CPC A46B 13/02; A46B 5/005; A46B 5/0054; A46B 5/0095; A46B 9/02; A46B 13/008; B25G 1/04; B25G 3/38; A46B 2200/30

(57) ABSTRACT

A power tool for cleaning includes: a cleaning device including a working accessory for cleaning; a driving device, where the driving device includes a motor for driving the working accessory to rotate, and the motor includes a motor shaft rotating about a first straight line; an operation device for a user to operate so as to control the power tool; a power supply device for supplying power to the driving device; and a connecting device for connecting the driving device to the operation device. The operation device includes a main handle for the user to hold. The power supply device is disposed between the main handle and the driving device. The fatigue degree of the user is reduced when the user operates the power tool.

### RELATED APPLICATION INFORMATION

This application is a continuation of International Application Number PCT/CN2024/080221, filed on Mar. 6, 2024, through which this application also claims the benefit under 35 U.S.C. § 119(a) of Chinese Patent Application No. 202310257460.1, filed on Mar. 16, 2023, which applications are incorporated herein by reference in their entireties.

### TECHNICAL FIELD

The present application relates to a power tool for cleaning and, in particular, to an electric cleaning brush.

### BACKGROUND

A cleaning brush is a power tool for cleaning, which is mainly used for cleaning floors and may also be used for cleaning walls or the surfaces of other objects. Ordinary cleaning brushes are laborious to use, and the cleaning effects need to be improved.

This part provides background information related to the present application, and the background information is not necessarily the existing art.

### SUMMARY

A power tool for cleaning includes: a cleaning device including a working accessory for cleaning; a driving device, where the driving device includes a motor for driving the working accessory to rotate, and the motor includes a motor shaft rotating about a first straight line; an operation device for a user to operate so as to control the power tool; a power supply device for supplying power to the driving device; and a connecting device for connecting the driving device to the operation device. The operation device includes a main handle for the user to hold, and the power supply device is disposed between the main handle and the driving device.

In some examples, the power supply device includes a power supply housing for accommodating a battery pack, and the power supply housing is disposed between the main handle and the driving device.

In some examples, the operation device further includes an auxiliary handle for cooperating with the main handle to allow the user to hold the main handle and the auxiliary handle with both hands, respectively, where the power supply housing is disposed between the main handle and the auxiliary handle.

In some examples, the auxiliary handle is configured to be annular or U-shaped.

In some examples, the connecting device further includes an auxiliary grip for cooperating with the main handle to allow the user to hold the main handle and the auxiliary grip with both hands, respectively, where the power supply housing is disposed between the main handle and the auxiliary grip.

In some examples, the connecting device extends along the direction of a second straight line, and the main handle includes a first grip provided at the end of the main handle facing the power supply housing and a second grip provided at the end of the main handle away from the power supply housing, where the first grip extends along the direction of the second straight line, and the extension direction of the second grip is inclined with respect to the second straight line.

In some examples, the included angle formed between the extension direction of the second grip and the second straight line is greater than or equal to 5° and less than or equal to 50°.

In some examples, the power supply device includes the battery pack, the battery pack is configured to provide a direct current power supply for the motor, the power supply housing includes an accommodation compartment for accommodating the battery pack, the connecting device extends along the direction of a second straight line, and the battery pack enters the accommodation compartment along a direction parallel to or inclined with respect to the direction of the second straight line.

In some examples, the operation device further includes a switch assembly capable of controlling the driving device to start or stop, and the switch assembly is disposed opposite to a power supply housing.

In some examples, the switch assembly includes a speed control switch configured to adjust the rotational speed of the motor.

In some examples, the operation device further includes a switch shield for covering the switch assembly.

In some examples, the connecting device is hinged to the driving device through a hinge assembly, and the connecting device is rotatable within a preset angle range by using a third straight line as a rotation axis.

In some examples, the distance L2 between the third straight line and the first straight line is less than or equal to the maximum distance L1 between the cleaning device and the first straight line in a front and rear direction.

In some examples, the power supply device includes a battery pack configured to provide a direct current power supply for the motor, and the voltage of the battery pack is one of 12 V, 18 V, 24 V, 36 V, and 56 V.

In some examples, the driving device further includes a transmission assembly for transmitting the torque of the motor to the working accessory, a first device housing for accommodating the motor, and a second device housing for accommodating the transmission assembly, where a waterproof sealing gasket is disposed at the connection interface between the first device housing and the second device housing.

In some examples, the transmission assembly is a planetary gear set.

In some examples, the power supply device includes a battery pack configured to provide a direct current power supply for the motor and a power supply housing for accommodating the battery pack, where the power supply housing includes an accommodation compartment for accommodating the battery pack.

In some examples, the accommodation compartment includes: a first compartment body for forming a cavity for accommodating the battery pack, where the first compartment body has an opening for allowing the battery pack to enter the cavity; and a second compartment body for covering the opening.

In some examples, the accommodation compartment is disposed under the operation device.

In some examples, the motor has a rotational speed of 12000 to 25000 revolutions per minute.

In some examples, the working accessory has a rotational speed of 250 to 600 revolutions per minute.

In some examples, the connecting device includes a telescopic rod, the telescopic rod includes an extended state and a retracted state, and the ratio of the length of the telescopic rod in the retracted state to the length of the telescopic rod in the extended state is 0.4 to 0.8.

In some examples, the power tool includes a tool body, where the tool body includes the cleaning device, the driving device, the operation device, and the connecting device and has a weight of 1.5 kilograms to 3 kilograms.

In some examples, the tool body has a length of 50 centimeters to 150 centimeters.

In some examples, the center of gravity of the tool body is between the driving device and the operation device.

A power tool for cleaning includes: a cleaning device including a working accessory for cleaning; a driving device, where the driving device includes a motor for driving the working accessory to rotate, and the motor includes a motor shaft rotating about a first straight line; an operation device for a user to operate so as to control the power tool; a power supply device for supplying power to the driving device; and a connecting device for connecting the driving device to the operation device. The connecting device includes: a first connecting device connected to the driving device; and a second connecting device, where one end of the second connecting device is connected to the first connecting device, and the other end of the second connecting device is connected to the operation device. The first connecting device is detachably connected to the second connecting device.

In some examples, the connecting device further includes a first electrical plug-in connector assembly, and the first connecting device and the second connecting device are electrically connected to each other through the first electrical plug-in connector assembly.

In some examples, the first electrical plug-in connector assembly includes a first plug and a first socket and is configured as follows: the first electrical plug-in connector assembly is in the on state when the first plug is inserted into the first socket; and the first electrical plug-in connector assembly is in the off state when the first plug is removed from the first socket.

In some examples, the first plug is disposed at an end of the first connecting device, and the first socket is disposed at the end of the second connecting device connected to the first connecting device; or the first plug is disposed at an end of the second connecting device, and the first socket is disposed at the end of the first connecting device connected to the second connecting device.

In some examples, the power supply device includes a power supply housing for accommodating a battery pack, and the power supply housing is connected to the first connecting device.

In some examples, the connecting device further includes a third connecting device, an end of the third connecting device is connected to the second connecting device, and the third connecting device is detachably connected to the second connecting device; the operation device includes a main handle and an auxiliary handle, and the auxiliary handle is used for cooperating with the main handle to allow the user to hold the main handle and the auxiliary handle with both hands, respectively; and the main handle is connected to the third connecting device, and the auxiliary handle is connected to the second connecting device.

In some examples, the power supply device includes a power supply housing for accommodating a battery pack, and the power supply housing is connected to the third connecting device and is disposed between the main handle and the auxiliary handle.

In some examples, the connecting device further includes a second electrical plug-in connector assembly, and the third connecting device and the second connecting device are electrically connected to each other through the second electrical plug-in connector assembly. In some examples, the second electrical plug-in connector assembly includes a second plug and a second socket and is configured as follows: the second electrical plug-in connector assembly is in the on state when the second plug is inserted into the second socket; and the second electrical plug-in connector assembly is in the off state when the second plug is removed from the second socket.

In some examples, the second plug is disposed at an end of the second connecting device, and the second socket is disposed at the end of the third connecting device connected to the second connecting device; or the second plug is disposed at an end of the third connecting device, and the second socket is disposed at the end of the second connecting device connected to the third connecting device.

A power tool for cleaning includes: a cleaning device including a working accessory for cleaning; a driving device, where the driving device includes a motor for driving the working accessory to rotate, and the motor includes a motor shaft rotating about a first straight line; a power supply device for supplying power to the driving device; an operation device for a user to operate so as to control the power tool; and a connecting device for connecting the driving device to the operation device. The working accessory includes: a first cleaning accessory configured to be driven by the driving device to rotate; and a second cleaning accessory configured to be directly or indirectly driven to rotate by the rotating first cleaning accessory.

In some examples, the first cleaning accessory rotates in a first rotation direction, and the second cleaning accessory rotates in a second rotation direction and/or the first rotation direction, where the first rotation direction is opposite to the second rotation direction.

In some examples, the first cleaning accessory and the second cleaning accessory are disposed side by side.

In some examples, multiple second cleaning accessories are disposed symmetrically about the first cleaning accessory.

In some examples, the diameter of the first cleaning accessory is equal to the diameter of the second cleaning accessory.

In some examples, the number of second cleaning accessories rotating in the second rotation direction is equal to the number of second cleaning accessories rotating in the first rotation direction.

In some examples, multiple second cleaning accessories are configured to surround the first cleaning accessory.

In some examples, the first cleaning accessory is located at the geometric center of a pattern formed by the multiple second cleaning accessories.

In some examples, all of the multiple second cleaning accessories rotate in the second rotation direction.

In some examples, the diameter of the first cleaning accessory is equal to the diameter of the second cleaning accessory.

In some examples, the diameter of the first cleaning accessory is greater than the diameter of the second cleaning accessory.

In some examples, the working accessory has a diameter of 40 millimeters to 150 millimeters.

In some examples, on a projection plane perpendicular to the first straight line, projections of regions cleaned by two adjacent working accessories during rotation partially have an overlapping region.

In some examples, the cleaning device further includes a mounting frame, the working accessory is mounted to the mounting frame, and the mounting frame is configured to have one of a rectangular shape, a racetrack shape, a triangular shape, and a circular shape.

In some examples, on a projection plane perpendicular to the first straight line, a partial projection of a region cleaned by the working accessory during rotation is beyond the boundary of a projection of the mounting frame.

In some examples, the working accessory includes a brush disc mounted on the mounting frame and bristles mounted on the lower surface of the brush disc, where on a projection plane perpendicular to the first straight line, projections of part of the bristles are outside a projection region of the brush disc.

In some examples, the lower surface of the brush disc includes: a first region provided in the central region of the brush disc, where bristles mounted in the first region extend along a direction toward the center of the brush disc; a second region provided outside the first region, where the extension direction of each of bristles mounted in the second region is parallel to or inclined with respect to the first straight line; and a third region provided outside the second region, where bristles mounted in the third region extend along a direction away from the center of the brush disc.

In some examples, the ratio of the area of the region where the bristles are mounted to the total area of the lower surface of the brush disc is higher than or equal to 50% and lower than or equal to 95%.

In some examples, the ratio of the height of each of the bristles to the diameter of the lower surface of the brush disc is higher than or equal to 25% and lower than or equal to 50%.

A power tool for cleaning includes: a cleaning device including a working accessory for cleaning; a driving device, where the driving device includes a motor for driving the working accessory to rotate, and the motor includes a motor shaft rotating about a first straight line; a power supply device for supplying power to the driving device; an operation device for a user to operate so as to control the power tool; and a connecting device for connecting the driving device to the operation device. The power tool further includes: a quick clamp device configured to be capable of detachably connecting the cleaning device to the driving device. The cleaning device includes a mounting portion for being mounted to the quick clamp device. The quick clamp device includes: the state where a quick clamp is locked, where in the state where the quick clamp is locked, the quick clamp device is configured to be connected to the cleaning device and limit the movement of the cleaning device in the direction of the first straight line; and the state where the quick clamp is unlocked, where in the state where the quick clamp is unlocked, the quick clamp device is configured to be separable from the cleaning device and allow the movement of the cleaning device in the direction of the first straight line.

In some examples, the quick clamp device includes a limit member configured to limit the displacement of the mounting portion in the direction of the first straight line, where the limit member is connected to the mounting portion and limits the movement of the mounting portion in the direction of the first straight line in the state where the quick clamp is locked, and the limit member is configured to be separable from the mounting portion and allow the movement of the mounting portion in the direction of the first straight line in the state where the quick clamp is unlocked.

In some examples, the mounting portion includes a limit groove, where the limit member enters the limit groove and limits the movement of the mounting portion in the direction of the first straight line in the state where the quick clamp is locked, and the limit member leaves, in the state where the quick clamp is unlocked, the limit groove to be separated from the mounting portion.

In some examples, the quick clamp device further includes an unlocking assembly, and the unlocking assembly is used for allowing the limit member to move, so as to cause the limit member to be connected to the mounting portion or separated from the mounting portion.

In some examples, the unlocking assembly includes a first unlocking member, where the first unlocking member is capable of abutting against the limit member to cause the limit member to be connected to the mounting portion, and a first elastic assembly, where the first elastic assembly is capable of pressing against the first unlocking member in the direction of the first straight line to cause the first unlocking member to abut against the limit member, where the first unlocking member is configured to move in the direction of the first straight line to be capable of causing the limit member to be connected to the mounting portion or separated from the mounting portion.

In some examples, the first elastic assembly presses against the first unlocking member down along the direction of the first straight line, and the first unlocking member is configured to move down along the direction of the first straight line to be capable of causing the limit member to be separated from the mounting portion.

In some examples, the first unlocking member includes an abutment portion extending toward the mounting portion in a direction perpendicular to the first straight line, where the abutment portion is configured to: abut against the limit member in the state where the quick clamp is locked; and be separated from the limit member in the state where the quick clamp is unlocked.

In some examples, the unlocking assembly further includes a second unlocking member, the second unlocking member abuts against the first unlocking member, and the second unlocking member moves in a direction perpendicular to the first straight line to be capable of pushing the first unlocking member to move away from the limit member.

In some examples, the surface of the second unlocking member that abuts against and is in contact with the first unlocking member includes a bevel.

In some examples, the limit member is a sphere.

A power tool for cleaning includes: a cleaning device including a working accessory for cleaning; a driving device, where the driving device includes a motor for driving the working accessory to rotate about a first straight line, and the motor includes a motor shaft rotating about the first straight line; a power supply device for supplying power to the driving device; an operation device for a user to operate so as to control the power tool; and a connecting device for connecting the driving device to the operation device. The power tool further includes a rotary device, and the rotary device is configured to be capable of allowing the cleaning device to rotate by using the first straight line as a rotation axis.

In some examples, the rotary device includes: a rotation-locked state where the cleaning device is forbidden from rotating; and a rotation-unlocked state where the cleaning device is allowed to rotate about the first straight line.

In some examples, the rotary device includes a first locking member and a second elastic member, the cleaning device includes a first mating portion configured to be capable of meshing with at least part of the first locking member, and the second elastic member is configured to be capable of pressing against the first locking member down along the direction of the first straight line so as to cause the first locking member to mesh with the first mating portion, where the first locking member is configured to be rotatable about the first straight line in the rotation-unlocked state, and the first locking member is configured to be forbidden from rotating about the first straight line in the rotation-locked state.

In some examples, in the rotation-unlocked state, the cleaning device is configured to be capable of bearing an upward force along the direction of the first straight line so that the first locking member meshing with the first mating portion moves up to a preset position along the direction of the first straight line and then is capable of causing the rotary device to switch to the rotation-locked state.

In some examples, the surface of the first locking member facing the first mating portion is configured as a toothed disc, and the surface of the first mating portion facing the first locking member is configured as a toothed disc capable of meshing with the first locking member.

In some examples, the rotary device includes a second locking member, and the cleaning device includes a second mating portion configured to be connectable to at least part of the second locking member through a snap, where the second mating portion is connected to the second locking member through the snap in the rotation-locked state, and the second mating portion is separated from the second locking member in the rotation-unlocked state.

In some examples, in the rotation-unlocked state, the cleaning device is configured to be capable of bearing an upward force along the direction of the first straight line so that the second mating portion is movable up along the direction of the first straight line under the action of the upward force until the second mating portion is connected to the second locking member through the snap.

In some examples, the second locking member includes a protrusion portion, and the second mating portion includes a slot portion matching the shape of the protrusion portion.

In some examples, the rotary device includes a third locking member, the third locking member is configured as a sphere, and the cleaning device includes a third mating portion including a first groove and multiple second slots, where the dimension of each of the multiple second slots matches the dimension of the third locking member, and the first groove communicates with the multiple second slots, where the rotary device is configured as follows: the third locking member enters one second slot in the rotation-locked state; and the third locking member is capable of leaving and entering the second slot and is movable in the first groove in the rotation-unlocked state.

In some examples, in the rotation-unlocked state, the cleaning device is configured to be capable of bearing the upward force along the direction of the first straight line so that the third mating portion is movable up along the direction of the first straight line under the action of the upward force until the third locking member moves from the first groove to the second slot.

### BRIEF DESCRIPTION OF THE DRAWINGS

FIG. 1 is a perspective view of a power tool according to an example of the present application.

FIG. 2 is an exploded view showing a partial structure of a driving device and a partial structure of a connecting device in FIG. 1.

FIG. 3 is a perspective view of another auxiliary handle according to an example of the present application.

FIG. 4 is a perspective view of the power tool in FIG. 1 with an auxiliary grip.

FIG. 5 is a plan view of the power tool in FIG. 1.

FIG. 6 is a partial enlarged view of region A in FIG. 5.

FIG. 7 is a partial enlarged view of region B in FIG. 5.

FIG. 8A is a perspective view of a cleaning device in FIG. 1.

FIG. 8B is a bottom view of the cleaning device in FIG. 8A.

FIG. 9A is a perspective view of a cleaning device according to an example of the present application.

FIG. 9B is a bottom view of the cleaning device in FIG. 9A.

FIG. 10 is a bottom view of a working accessory in FIG. 8.

FIG. 11A is a perspective view showing a cleaning device and a driving device in FIG. 1 in the state where a quick clamp is locked.

FIG. 11B is a perspective view showing a cleaning device and a driving device in FIG. 1 in the state where the quick clamp is unlocked.

FIG. 12 is a perspective view showing a mounting portion and limit members in FIG. 11A.

FIG. 13 is a sectional view of the structure shown in FIG. 11A in the state where the quick clamp is locked.

FIG. 14 is a partial enlarged view of region C in FIG. 13.

FIG. 15 is a plan view of region C in FIG. 13 in the state where the quick clamp is unlocked.

FIG. 16 is a perspective view of a first elastic assembly in FIG. 13.

FIG. 17 is a sectional view of another quick clamp device applicable to the power tool in FIG. 1 according to the present application.

FIG. 18 is a partial enlarged view of region D in FIG. 17.

FIG. 19 is a partial enlarged view of region E in FIG. 18.

FIG. 20 is a sectional view of another quick clamp device applicable to the power tool in FIG. 1 according to the present application.

FIG. 21A is a partial enlarged view of region F in FIG. 20.

FIG. 21B is a plan view of region F in FIG. 20 in the state where the quick clamp is unlocked.

FIG. 22 is a perspective view of a second unlocking member in FIG. 20.

FIG. 23A is a view showing positional states of a first unlocking member and a second unlocking member in FIG. 20 in the state where the quick clamp is locked.

FIG. 23B is a view showing positional states of a first unlocking member and a second unlocking member in FIG. 20 in the state where the quick clamp is unlocked.

FIG. 24 is a top view of the power tool in FIG. 1 in a rotational state.

FIG. 25 is a perspective view of a cleaning device in FIG. 24.

FIG. 26 is a perspective view showing part of a rotary device and part of a cleaning device in FIG. 1.

FIG. 27A is a view showing positional states of a first locking member and a first mating portion in FIG. 26 in the rotation-locked state.

FIG. 27B is a view showing positional states of a first locking member and a first mating portion in FIG. 26 in the rotation-unlocked state.

FIG. 28A is a view showing that part of a first mating portion meshes with part of a first locking member before rotation.

FIG. 28B is a view showing the relative position between part of a first mating portion and part of a first locking member during rotation.

FIG. 28C is a view showing the relative position between part of a first mating portion and part of a first locking member during continued rotation.

FIG. 28D is a view showing that part of a first mating portion meshes with part of a first locking member after rotation.

FIG. 29 is a plan view showing that another rotary device applicable to the power tool in FIG. 1 is mounted to a cleaning device.

FIG. 30 is a sectional view showing that the rotary device in FIG. 29 is connected to part of a driving device and a cleaning device.

FIG. 31 is a partial enlarged view of region G in FIG. 30.

FIG. 32 is a perspective view showing that another rotary device applicable to the power tool in FIG. 1 is mounted to a cleaning device.

FIG. 33 is a perspective view showing a third locking member and a mounting portion in FIG. 32.

FIG. 34 is a plan view showing the third locking member and part of a device housing in FIG. 33.

FIG. 35 is a plan view of the mounting portion in FIG. 33.

FIG. 36A is a view showing the relative position between part of a third mating portion and part of third locking members in FIG. 35 before rotation.

FIG. 36B is a view showing the relative position between part of a third mating portion and part of third locking members in FIG. 35 during rotation.

FIG. 36C is another view showing the relative position between part of a third mating portion and part of third locking members in FIG. 35 during rotation.

FIG. 36D is a view showing the relative position between part of a third mating portion and part of third locking members in FIG. 35 after rotation.

FIG. 37A is a perspective view of a power tool according to an example of the present application.

FIG. 37B is a perspective view of the power tool in FIG. 37A with a second connecting device detached.

FIG. 38A is a view showing a partial structure of a third connecting device in FIG. 37A.

FIG. 38B is a view showing a partial structure of a second connecting device in FIG. 37A.

FIG. 38C is a view showing a partial structure of a first connecting device in FIG. 37A.

FIG. 39 is a perspective view of a first electrical plug-in connector assembly in FIG. 37A.

FIG. 40 is a plan view of a power tool according to an example of the present application.

FIG. 41A is a view showing a partial structure of the disassembled power tool in FIG. 40 including a second connecting device.

FIG. 41B is a view showing a partial structure of the disassembled power tool in FIG. 40 including a first connecting device.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

The present application is described below in detail in conjunction with drawings and examples. It is to be understood that the examples described herein are intended to explain the present application and not to limit the present application. The present application includes multiple examples. For the sake of brevity, the same or similar reference numerals are used for the same or similar components or features in different examples. Moreover, it is also to be noted that compatible portions in different examples are each applicable to other examples. In addition, for ease of description, only part, not all, of structures or steps related to the present application are illustrated in the drawings.

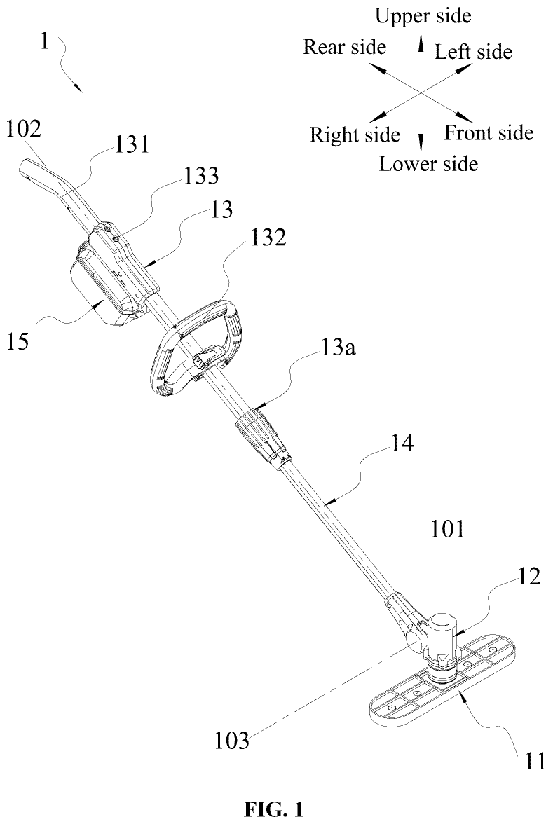

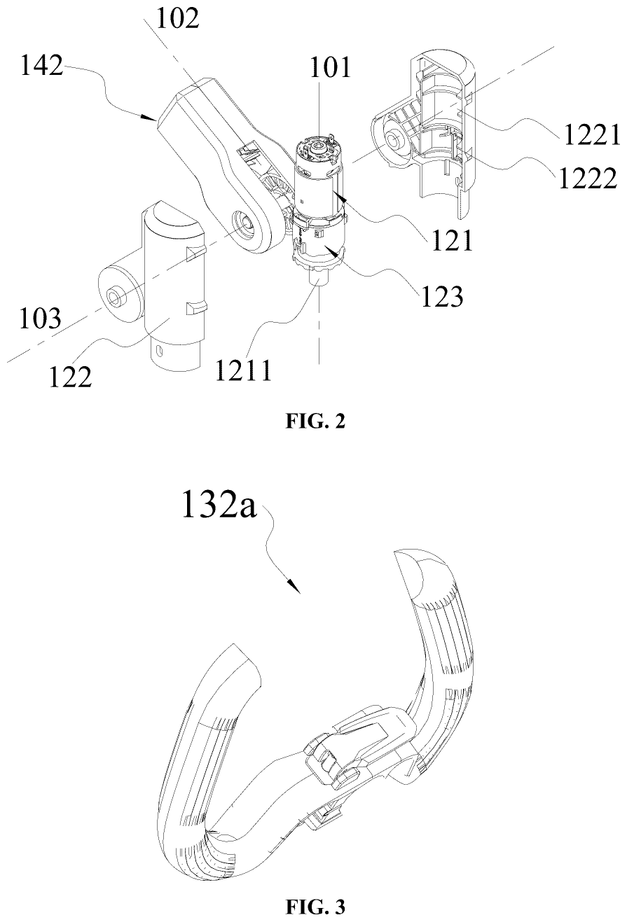

A power tool 1 for cleaning shown in FIG. 1 is used for cleaning floors, walls, and the like. As shown in FIGS. 1 and 2, the power tool 1 includes a cleaning device 11, a driving device 12, an operation device 13, a connecting device 14, and a power supply device 15. The cleaning device 11, the driving device 12, the operation device 13, and the connecting device 14 may be considered as a tool body 13a. In some examples, the tool body 13a has a weight of 1.5 kilograms to 3 kilograms and has a length of 50 centimeters to 150 centimeters, and the center of gravity of the tool body 13a is between the driving device 12 and the operation device 13.

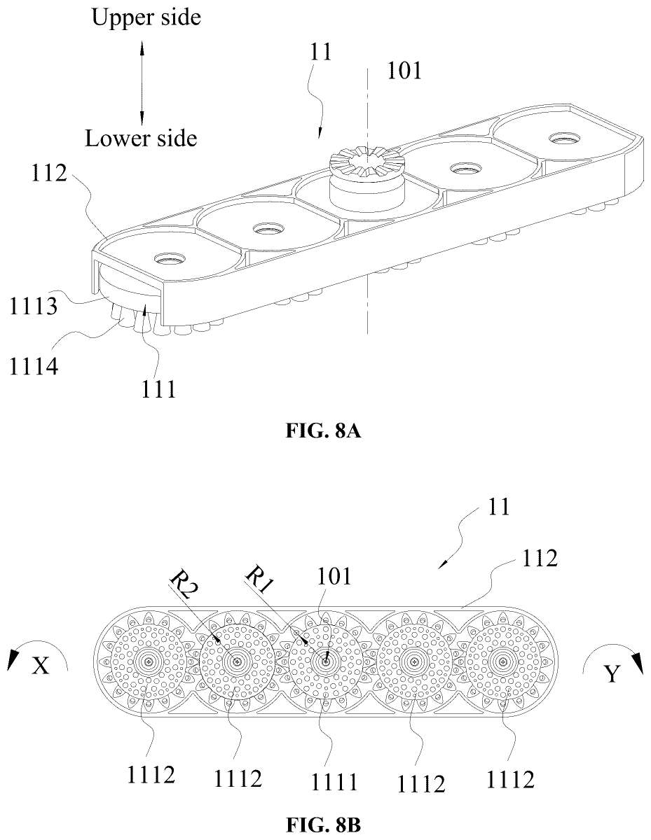

The cleaning device 11 is used for mounting a working accessory 111 (see FIGS. 8 to 10) to implement a cleaning function. The working accessory 111 may be a component for cleaning such as a brush or a scouring pad. To facilitate the description of technical solutions of the present application, an upper side, a lower side, a front side, a rear side, a left side, and a right side shown in FIG. 1 are defined. The driving device 12 is disposed on the upper side of the cleaning device 11, and the cleaning device 11 is disposed on the lower side of the driving device 12. A front and rear direction is perpendicular to an up and down direction and a left and right direction.

The driving device 12 is used for providing power for the cleaning device 11 to rotate. As shown in FIG. 2, the driving device 12 includes a motor 121 and a device housing 122. The motor 121 is disposed in the device housing 122. The motor 121 includes a motor shaft 1211 that rotates about a first straight line 101 and drives at least one working accessory 111 of the cleaning device 11 to rotate. In some examples, the motor 121 has a rotational speed of 12000 to 25000 revolutions per minute, and the working accessory 111 driven by the motor 121 has a rotational speed of 250 to 600 revolutions per minute. In some examples, the driving device 12 also includes a transmission assembly 123. The transmission assembly 123 is used for transmitting the torque of the motor 121 to the working accessory 111 so as to cause the working accessory 111 to rotate. The transmission assembly 123 may be a planetary gear set and may also be disposed in the device housing 122. In some examples, to enhance the waterproof performance of the driving device, the device housing 122 includes a first device housing 1221 and a second device housing 1222, as shown in FIG. 2. The first device housing 1221 is used for accommodating the motor 121, and the second device housing 1222 is used for accommodating the transmission assembly 123. A waterproof sealing gasket (not shown in the figure) is disposed at the connection interface between the first device housing 1221 and the second device housing 1222.

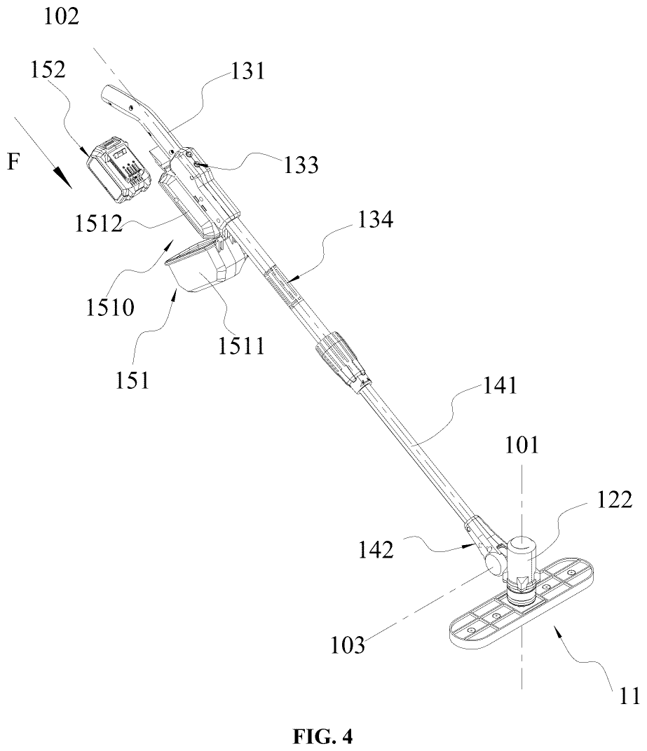

The operation device 13 includes a main handle 131, an auxiliary handle 132, and a switch assembly 133. The main handle 131 is used for a user to hold. The switch assembly 133 can control the driving device 12 to start or stop. The switch assembly 133 may be disposed on the main handle 131 so that the user can directly operate the switch assembly 133 so as to control the power tool 1 to perform cleaning when holding the main handle 131. The switch assembly 133 may also include a speed control switch (not shown in the figure) configured to adjust the rotational speed of the motor 121. The speed control switch may or may not include a circuit board with control logic for speed control. The auxiliary handle 132 is used for cooperating with the main handle 131 so that the user holds the main handle 131 and the auxiliary handle 132 with both hands, respectively. Thus, the power tool 1 can be operated more stably. The auxiliary handle 132 may be an annular auxiliary handle 132 as shown in FIG. 1 or a U-shaped auxiliary handle 132a as shown in FIG. 3. In some examples, as shown in FIG. 4, the operation device 13 may be provided with an auxiliary grip 134 to replace the auxiliary handle 132. The auxiliary grip 134 may be disposed on the surface of the connecting device 14. Scores or bumps may be provided on the surface of the auxiliary grip 134 to increase the friction of the user's palm. Specifically, the auxiliary grip 134 may be disposed at the position where the auxiliary handle 132 is mounted on the connecting device 14. In some examples, the operation device 13 also includes a switch shield (not shown in the figure) for shielding the switch assembly 133 to prevent dust from entering the switch assembly 133 or prevent water from splashing into the switch assembly 133 during cleaning. In other examples, the operation device 13 may also include a hanging portion (not shown in the figure) for allowing the user to hang the power tool 1.

As shown in FIG. 4, the connecting device 14 includes a connecting rod 141 for connecting the power supply device 15 to the device housing 122. The connecting rod 141 extends along the direction of a second straight line 102. In some examples, the connecting device 14 also includes a hinge assembly 142. The hinge assembly 142 connects the connecting rod 141 to the device housing 122 and allows the connecting rod 141 to rotate within a preset angle range by using a third straight line 103 as a rotation axis. In some examples, the connecting device 14 also includes a telescopic rod (not shown in the figure). The telescopic rod includes an extended state and a retracted state. The ratio of the length of the telescopic rod in the retracted state to the length of the telescopic rod in the extended state is 0.4 to 0.8.

The power supply device 15 may include a power supply housing 151 and a battery pack 152 capable of providing a direct current power supply for the motor 121. Optionally, the voltage of the battery pack 152 may be one of 12 V, 18 V, 24 V, 36 V, 40 V, 56 V, and 80 V. In other examples, the power supply device 15 may also include a rectifier module (not shown in the figure). The rectifier module can convert an alternating current into a direct current, thereby allowing the power tool 1 to access an alternating current from mains electricity. The power supply housing 151 is used for forming an accommodation compartment 1510 for accommodating the power supply device 15. For example, the accommodation compartment 1510 can accommodate one or more battery packs 152 to supply power to the power tool 1. The accommodation compartment 1510 can prevent liquids from splashing into the battery pack 152 during cleaning. As shown in FIG. 4, the accommodation compartment 1510 includes a first compartment body 1511 and a second compartment body 1512. The first compartment body 1511 is used for forming a cavity for accommodating the battery pack 152. The first compartment body 1511 has an opening that allows the battery pack 152 to enter the cavity, and the second compartment body 1512 is used for covering the opening. In some examples, the accommodation compartment 1510 is disposed under the operation device 13. Specifically, the second compartment body 1512 is disposed under the main handle 131.

The power supply housing 151 and the auxiliary handle 132 may be mounted to the connecting rod 141. The auxiliary handle 132 or the auxiliary grip 134 may be mounted between the device housing 122 and the power supply housing 151. In other examples, the power supply housing 151 may also be formed with a coupling portion (not shown in the figure) configured to be coupled to the power supply device 15. For example, one battery pack 152 can be inserted into and coupled to the coupling portion to supply power to the power tool 1. The battery pack 152 can enter the accommodation compartment 1510 or be inserted into the coupling portion along a first direction F, where the first direction F is parallel to or inclined with respect to the second straight line 102. In this example, the main handle 131 and the power supply housing 151 are formed separately. It is to be understood that in some other examples, the main handle 131 may be integrally formed with the power supply housing 151. In some examples, the switch assembly 133 may be disposed on the upper surface of the power supply housing 151 to reduce the occupied space, thereby facilitating the miniaturized design of the power tool 1.

In some examples, the power supply housing 151 is disposed behind the main handle 131. That is, the main handle 131 is disposed between the power supply housing 151 and the connecting rod 141, or the main handle 131 is disposed between the power supply housing 151 and the auxiliary handle 132 or the auxiliary grip 134. Such a structural arrangement causes the gravity borne by the power supply housing 151 to generate a downward force on the connecting device 14 when the user cleans a floor, and the user needs to apply an upward force to the main handle 131 to lift the connecting device 14. According to the lever rule, to reduce the magnitude of the force applied by the user's palm to the main handle 131, the power supply housing 151 may be disposed forward, that is, the power supply housing 151 may be disposed in a direction close to the driving device 12. As shown in FIGS. 1 and 4, the present application provides a technical solution. In this example, the power supply housing 151 is disposed between the main handle 131 and the driving device 12. Specifically, the power supply housing 151 may be disposed between the main handle 131 and the auxiliary handle 132 or the auxiliary grip 134, thereby reducing the magnitude of the force applied by the user's palm to the main handle 131 and reducing the user's fatigue when the user operates the power tool 1.

When using a power tool such as a cleaning brush to clean a floor, the user applies a forward force or a rearward force parallel to the floor to the handle, so as to push the cleaning brush forward or rearward to clean the floor. In some examples, the main handle 131 is configured to have a straight handle structure (not shown in the figure). The straight handle structure is typically parallel to the extension direction of the connecting rod 141, and the extension direction of the connecting rod 141 is inclined with respect to a horizontal plane. Therefore, the main handle configured to have the straight handle structure causes the direction of the force applied by the palm of the user when cleaning the floor to be inconsistent with the movement direction of the power tool. As a result, the user's palm bears great resistance, which easily causes palm fatigue after long-time work. Therefore, it is difficult for the user to continuously work for a long time.

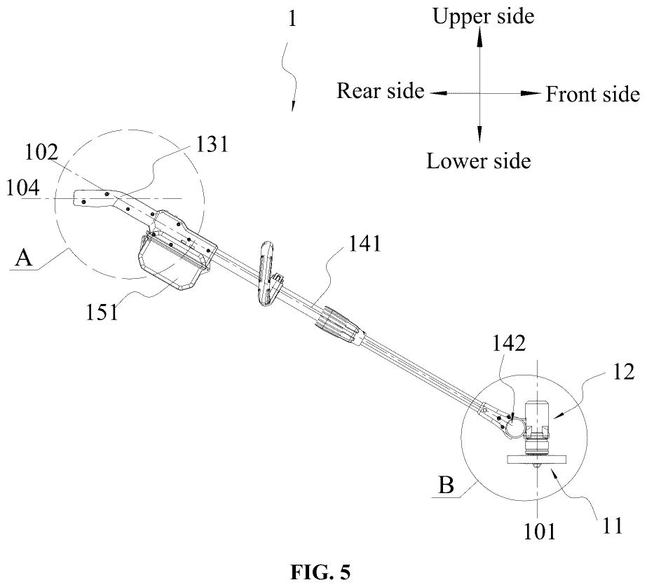

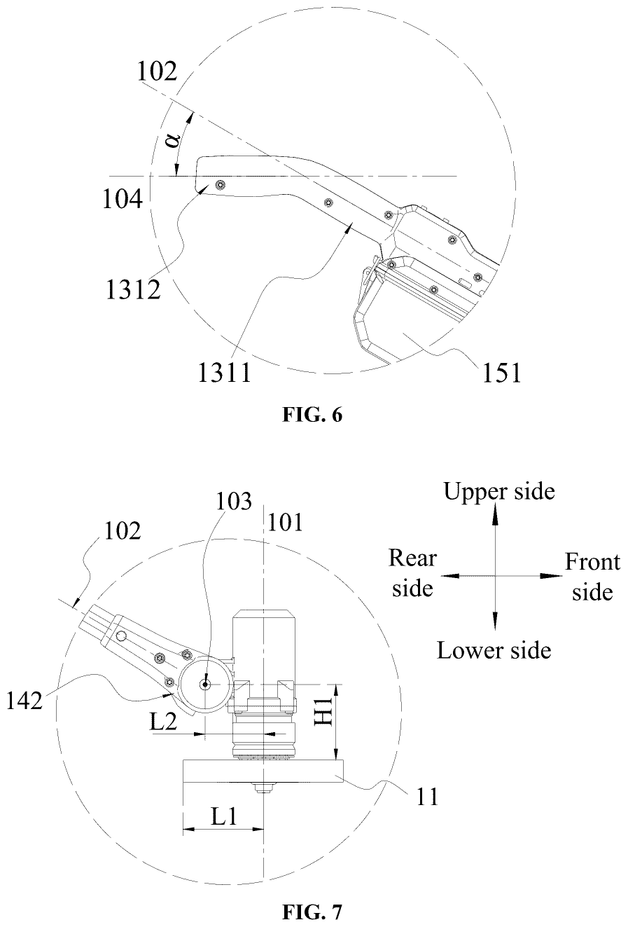

As shown in FIGS. 5 and 6, the main handle 131 includes a first grip 1311 and a second grip 1312. The first grip 1311 is provided at the end of the main handle 131 facing the power supply housing 151, and the second grip 1312 is provided at the end of the main handle 131 away from the power supply housing 151. The first grip 1311 extends along the direction of the second straight line 102, and the extension direction of the second grip 1312 is inclined with respect to the second straight line 102. Optionally, the second grip 1312 extends along the direction of a fourth straight line 104. The fourth straight line 104 is inclined with respect to the second straight line 102 and may be parallel to or inclined with respect to the floor. Specifically, the included angle α between the fourth straight line 104 and the second straight line 102 is 5° to 50°. For example, the included angle α may be 15°, 30°, or 45°. In the present application, the user may hold the second grip 1312 when cleaning the floor. The extension direction of the second grip 1312 is substantially parallel to the floor. Thus, the direction of the force applied by the user's palm can be substantially consistent with the movement direction of the power tool 1, thereby reducing the fatigue degree of the user's palm.

As shown in FIG. 7, in the front and rear direction, the maximum distance between the cleaning device 11 and the first straight line 101 is L1. The maximum distance L1 may be the distance between the outermost housing of the cleaning device 11 in the front and rear direction and the first straight line 101. The distance between the third straight line 103 and the first straight line 101 is L2. The distance L2 may be the sum of a half of the outer diameter of the housing of the hinge assembly 142 and a half of the outer diameter of the device housing 122. In some examples, L1 is greater than or equal to L2. Thus, when the user rotates the connecting rod 141, the cleaning device 11 can provide a relatively great support force to prevent the power tool 1 from tipping over. In some examples, the minimum distance between the cleaning device 11 and the third straight line 103 in the up and down direction is H1. The minimum distance H1 may be the distance between the uppermost housing of the cleaning device 11 and the third straight line 103. Optionally, H1 may be 10 millimeters to 100 millimeters so that interference with the cleaning device 11 is avoided when the user rotates the connecting rod 141.

In some examples, the power tool 1 may further include an illumination device (not shown in the figure) for providing a supplementary light source. Specifically, the illumination device may be connected to the driving device 12 or the connecting rod 141. In some examples, the power tool 1 may further include a water absorption device (not shown in the figure) for absorbing liquids, such as cleaning waste water remaining on the floor. In some examples, the power tool 1 may further include a liquid discharge device (not shown in the figure) for discharging cleaning liquids or clean water. For example, the liquid discharge device can drip the cleaning liquids to assist in cleaning oil stains on the floor, or the liquid discharge device can spray clean water to flush the floor. In some examples, the power tool 1 may further include an external hanging device (not shown in the figure) for mounting an external water pipe to flush the floor.

As shown in FIGS. 8A and 8B, the present application provides the cleaning device 11. The cleaning device 11 includes the working accessory 111 and a mounting frame 112. The working accessory 111 is mounted on the mounting frame 112, and the mounting frame 112 can be detachably mounted to the device housing 122. In this example, the working accessory 111 is a brush. In other examples, the working accessory 111 may be a cleaning component such as a scouring pad. The type of the working accessory 111 is not limited in the present application.

For the reduction of a dead angle of the cleaning device 11 during cleaning, in some examples, on a projection plane perpendicular to the first straight line 101, projections of regions cleaned by two adjacent working accessories 111 during rotation partially have an overlapping region. For the maximization of the area of a region cleaned by the cleaning device 11, in some examples, on the projection plane perpendicular to the first straight line 101, a partial projection of a region cleaned by the working accessory 111 during rotation is beyond the boundary of a projection of the mounting frame 112.

The working accessory 111 may include a first cleaning accessory 1111 and a second cleaning accessory 1112. The first cleaning accessory 1111 is configured to be driven by the driving device 12 to rotate about the first straight line 101. The second cleaning accessory 1112 is configured to be driven to rotate by the rotating first cleaning accessory 1111 or another second cleaning accessory 1112. The rotation axis of the second cleaning accessory 1112 is parallel to the first straight line 101. The first cleaning accessory 1111 rotates in a first rotation direction X. Second cleaning accessories 1112 rotate in a second rotation direction Y, or part of second cleaning accessories 1112 rotate in the first rotation direction X. The first rotation direction X is opposite to the second rotation direction Y. For example, the first rotation direction X may be a clockwise direction, or the second rotation direction Y may be a clockwise direction.

As shown in FIGS. 8A and 8B, the first cleaning accessory 1111 and the second cleaning accessories 1112 may be disposed side by side. Specifically, the mounting frame 112 may be rectangular or racetrack-shaped. The working accessory 111 includes the first cleaning accessory 1111 and the multiple second cleaning accessories 1112. The multiple second cleaning accessories 1112 are disposed symmetrically about the first cleaning accessory 1111. Part of the second cleaning accessories 1112 rotate in the first rotation direction X, and the other part of the second cleaning accessories 1112 rotate in the second rotation direction Y. In addition, the number of the second cleaning accessories 1112 rotating in the second rotation direction Y is equal to the number of the second cleaning accessories 1112 rotating in the first rotation direction X. The radius of the first cleaning accessory 1111 is R1, and the radius of the second cleaning accessory 1112 is R2. Optionally, each of R1 and R2 may be 20 millimeters to 75 millimeters. In this example, R1 may be equal to R2.

As shown in FIGS. 9A and 9B, the present application further provides a cleaning device 11a. A mounting frame 112a of the cleaning device 11a is substantially triangular. In other examples, the mounting frame 112a may be circular. In the cleaning device 11a, all second cleaning accessories 1112a are configured to surround a first cleaning accessory 1111a. The cleaning device 11a includes the first cleaning accessory 1111a and the multiple second cleaning accessories 1112a. The first cleaning accessory 1111a is located at the geometric center of a pattern formed by the multiple second cleaning accessories 1112a, and the pattern may be a triangle or a circle. The first cleaning accessory 1111a rotates in the first rotation direction X. All the second cleaning accessories 1112a rotate in the second rotation direction Y. The radius of the first cleaning accessory 1111 is R11, and the radius of each of the second cleaning accessories 1112a is R21. Optionally, each of R11 and R21 may be 20 millimeters to 75 millimeters. In this example, R11 may be greater than or equal to R21. In some examples, R11=N*R21, where the value of N is equal to the number of the second cleaning accessories 1112a.

As shown in FIGS. 8A and 8B, the working accessory 111 includes a brush disc 1113 and bristles 1114. The brush disc 1113 is mounted on the mounting frame 112. The bristles 1114 are mounted on the lower surface of the brush disc 1113. For the maximization of the area of the region cleaned by the cleaning device 11, in some examples, on the projection plane perpendicular to the first straight line 101, projections of part of the bristles 1114 are outside a projection region of the brush disc 1113. In some examples, the ratio of the area of the region where the bristles 1114 are mounted to the total area of the lower surface of the brush disc 1113 ranges from 50% to 95%. In some examples, the ratio of the height of each of the bristles 1114 to the diameter D1 of the lower surface of the brush disc 1113 ranges from 25% to 50%.

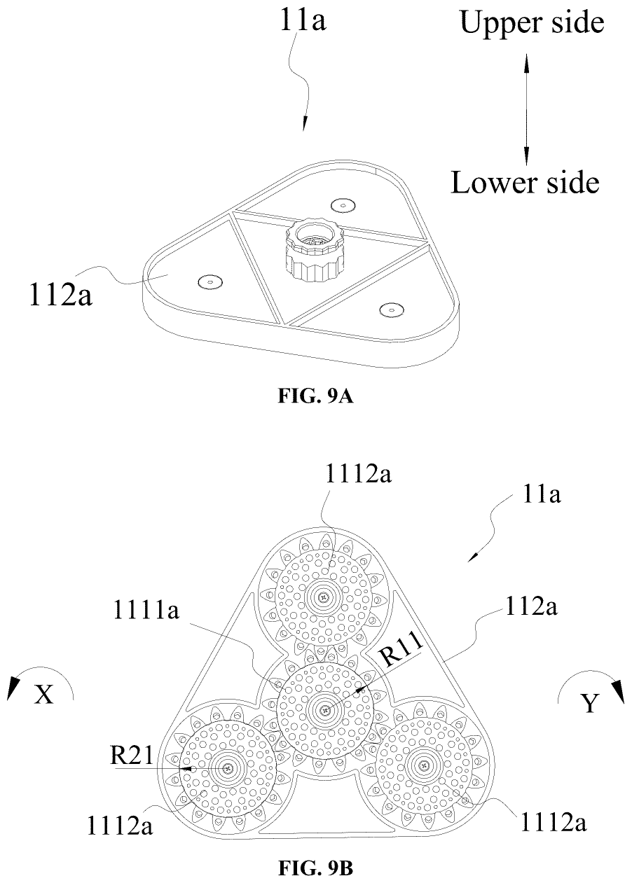

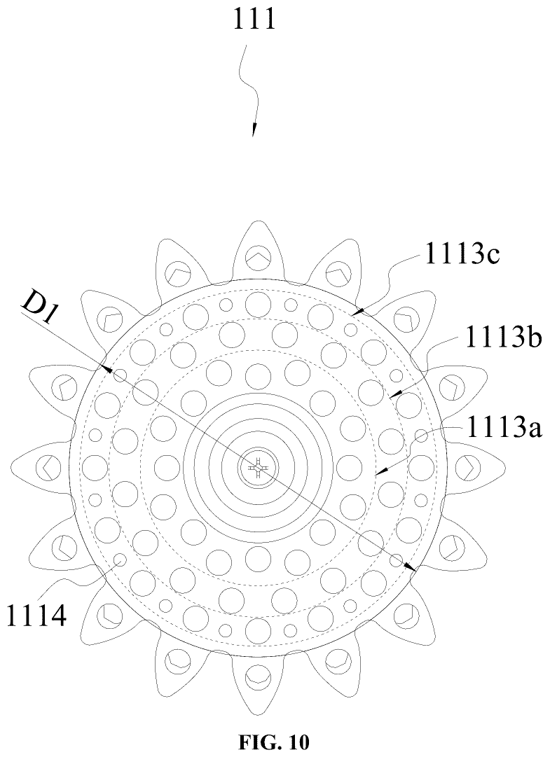

As shown in FIG. 10, for the reduction of the dead angle of the cleaning device 11 during cleaning, in some examples, the lower surface of the brush disc 1113 includes a first region 1113a, a second region 1113b, and a third region 1113c. The first region 1113a is provided in the central region of the brush disc 1113, where bristles 1114 mounted in the first region 1113a extend along a direction toward the center of the brush disc 1113. The second region 1113b is provided outside the first region 1113a, where the extension direction of each of bristles 1114 mounted in the second region 1113b is parallel to or inclined with respect to the first straight line 101. The third region 1113c is provided outside the second region 1113b, where bristles 1114 mounted in the third region 1113c extend along a direction away from the center of the brush disc 1113. Thus, the bristles 1114 of adjacent working accessories 111 mounted in the third region 1113c cross so that the regions cleaned by the two adjacent working accessories 111 during rotation have an overlapping region.

As shown in FIGS. 11A to 23, the present application further provides a power tool 1 for cleaning including a quick clamp device 16. The quick clamp device 16 is mounted in the device housing 122 and can detachably connect the cleaning device to the driving device. Thus, the user can detach and replace the cleaning device during work. For example, the cleaning device 11 shown in FIG. 8 is replaced with the cleaning device 11a shown in FIG. 9 for adaptation to changing cleaning needs, or an old damaged cleaning device is replaced with a new cleaning device. The quick clamp device provided in the present application allows the user to operate it with one hand to replace the cleaning device.

As shown in FIGS. 11A to 16, the present application provides a first type of quick clamp device 16. The cleaning device 11 includes a mounting portion 113 configured to be detachably connected to the quick clamp device 16. The mounting portion 113 is mounted on the upper surface of the mounting frame 112. The mounting portion 113 and the mounting frame 112 may be integrally formed or fixed to each other through welding.

The quick clamp device 16 includes the state where a quick clamp is locked and the state where the quick clamp is unlocked. In the state where the quick clamp is locked, the quick clamp device 16 is connected to the cleaning device 11 and limits the movement of the cleaning device 11 in the direction of the first straight line 101. In the state where the quick clamp is unlocked, the quick clamp device 16 is separable from the cleaning device 11 and allows the movement of the cleaning device 11 in the direction of the first straight line 101.

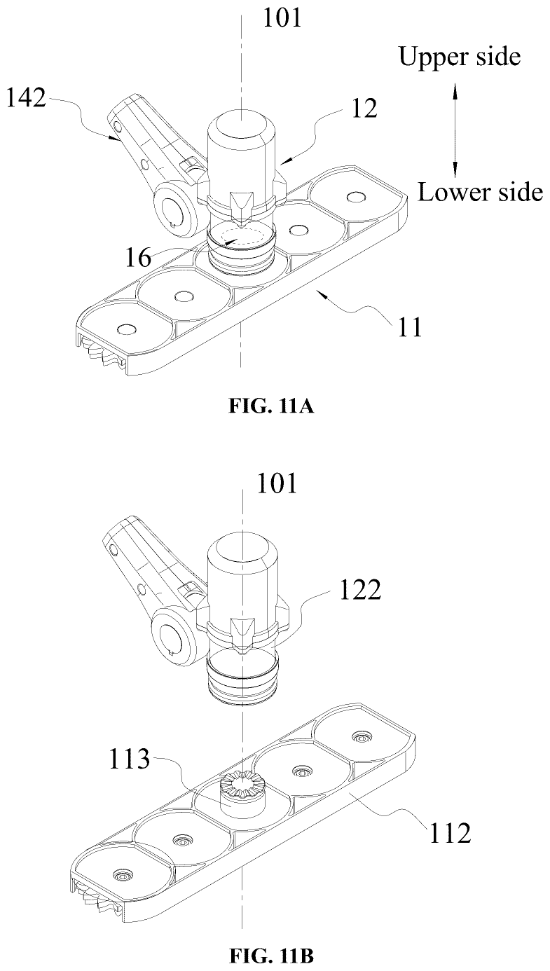

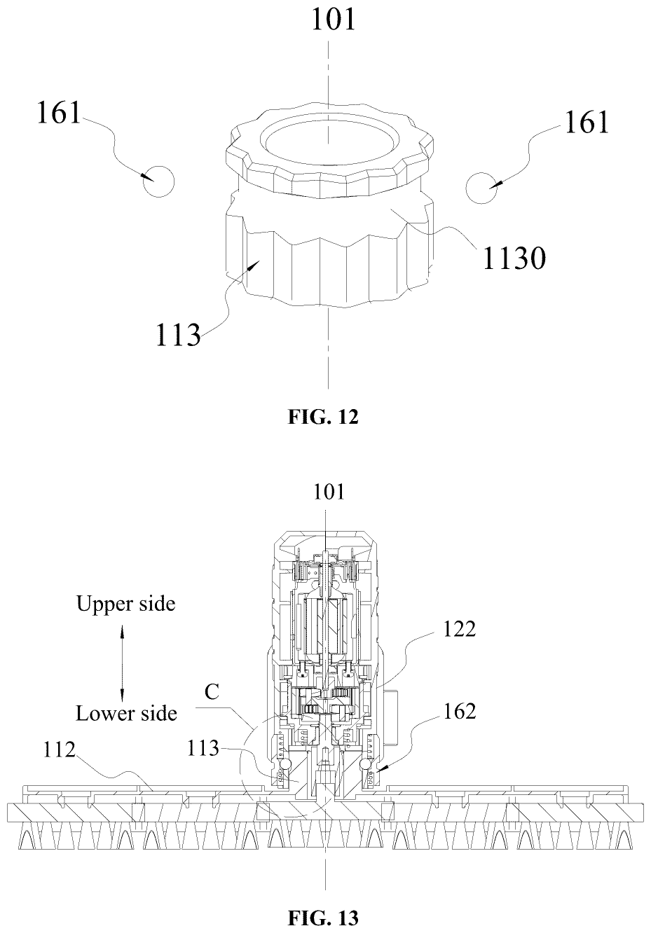

As shown in FIGS. 12 to 15, the quick clamp device 16 includes a limit member 161 configured to limit the displacement of the mounting portion 113 in the direction of the first straight line 101. The limit member 161 is connected to the mounting portion 113 and limits movement of the mounting portion 113 in the direction of the first straight line 101 in the state where the quick clamp is locked. The limit member 161 is separated from the mounting portion and can allow the movement of the mounting portion 113 in the direction of the first straight line 101 in the state where the quick clamp is unlocked.

Specifically, the mounting portion 113 includes a limit groove 1130, the limit member 161 may be a sphere, and at least part of the limit member 161 can enter the limit groove 1130. The limit member 161 enters the limit groove 1130 and limits the movement of the mounting portion 113 in the direction of the first straight line 101 in the state where the quick clamp is locked. The limit member 161 can leave, in the state where the quick clamp is unlocked, the limit groove 1130 to be separated from the mounting portion 113. Thus, the mounting portion 113 can be allowed to move along the direction of the first straight line 101.

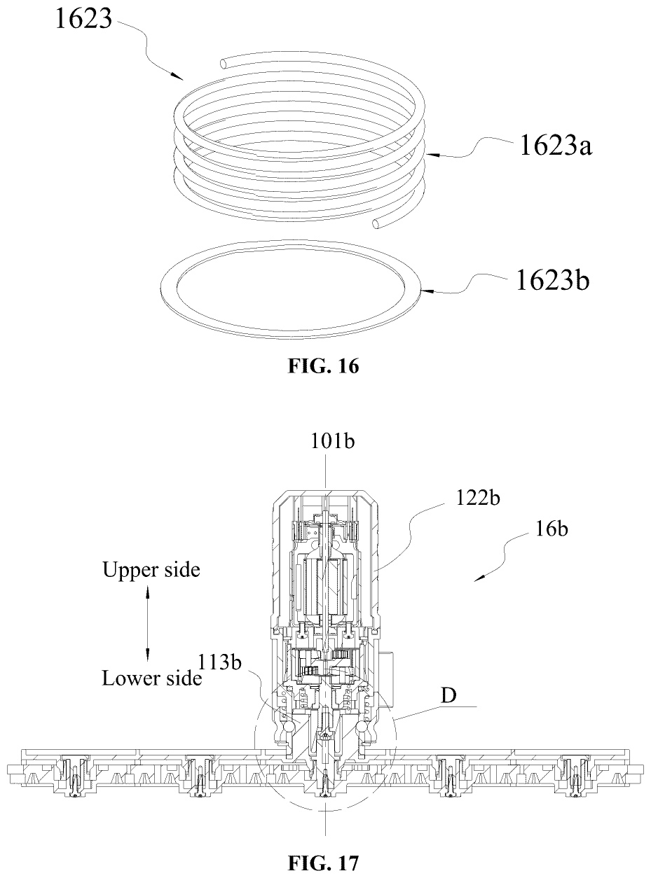

As shown in FIGS. 13 to 16, the quick clamp device 16 further includes an unlocking assembly 162. The unlocking assembly 162 can move the limit member 161 to cause the limit member 161 to be connected to the mounting portion 113 or separated from the mounting portion 113. Specifically, the unlocking assembly 162 includes a first unlocking member 1621 and a first elastic assembly 1623. The first unlocking member 1621 is capable of abutting against the limit member 161 to cause the limit member 161 to be connected to the mounting portion 113. The first unlocking member 1621 may be configured as part of the surface of the inner wall of the device housing 122. The first unlocking member 1621 moves in the direction of the first straight line 101 to be capable of driving the limit member 161 to enter the limit groove 1130 or allowing the limit member 161 to leave the limit groove 1130, thereby allowing the limit member 161 to be connected to or separated from the mounting portion 113. The first elastic assembly 1623 can press against the first unlocking member 1621 down along the direction of the first straight line 101 to cause the first unlocking member 1621 to abut against the limit member 161. Specifically, as shown in FIG. 16, the first elastic assembly 1623 includes a first elastic member 16231 and an intermediate member 16232. The first elastic member 16231 may be a spring, and the intermediate member 16232 may be an annular member such as a gasket. The first elastic member 16231 is disposed above the intermediate member 16232, and the intermediate member 16232 is disposed above the first unlocking member 1621. The intermediate member 16232 presses against the first unlocking member 1621 under the action of the force of the first elastic member 16231.

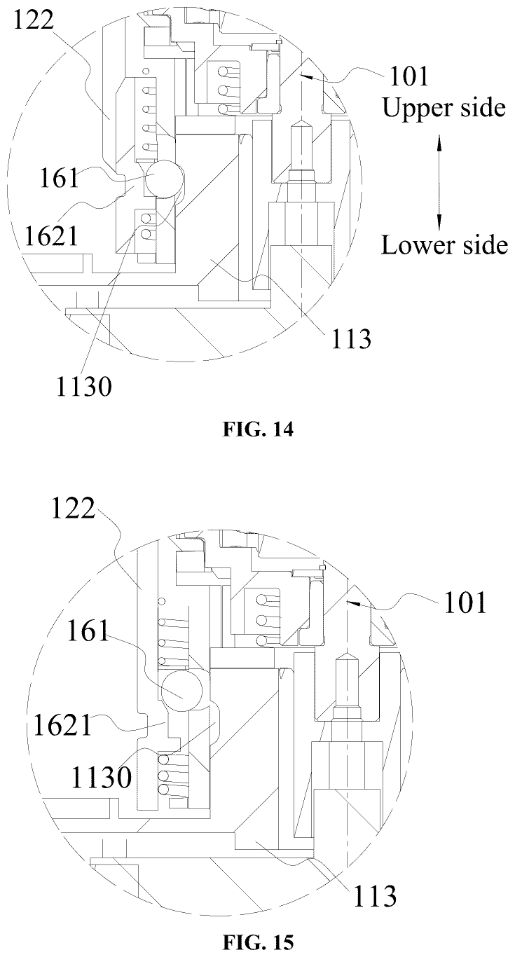

As shown in FIG. 14, in the state where the quick clamp is locked, the first elastic assembly 1623 applies a downward force to the first unlocking member 1621 in the direction of the first straight line 101 to drive the first unlocking member 1621 to press against the limit member 161 and cause the limit member 161 to enter the limit groove 1130 so that the mounting portion 113 is stuck. Thus, the movement of the mounting portion 113 in the direction of the first straight line 101 is limited. In this case, if a downward force along the direction of the first straight line 101 is applied to the device housing 122, the device housing 122 can drive the first unlocking member 1621 to move down along the direction of the first straight line 101, that is, a movement space is provided for the limit member 161 to leave the limit groove 1130. When the first unlocking member 1621 moves down along the direction of the first straight line 101 to the position shown in FIG. 15, the limit member 161 can gradually leave the limit groove 1130 under the action of a bevel of part of the inner wall of the limit groove 1130.

As shown in FIG. 15, in the state where the quick clamp is unlocked, the limit member 161 completely leaves the limit groove 1130 and is separated from the mounting portion 113, and the mounting portion 113 is no longer stuck in the device housing 122. Thus, the user can be allowed to operate the mounting portion 113 with one hand so that the mounting portion 113 moves in the direction of the first straight line 101.

As shown in FIGS. 17 to 19, the present application provides a second type of quick clamp device 16b. When an upward force along the direction of a first straight line 101b is applied to a device housing 122b, the quick clamp device 16b switches from the state where the quick clamp is locked to the state where the quick clamp is unlocked.

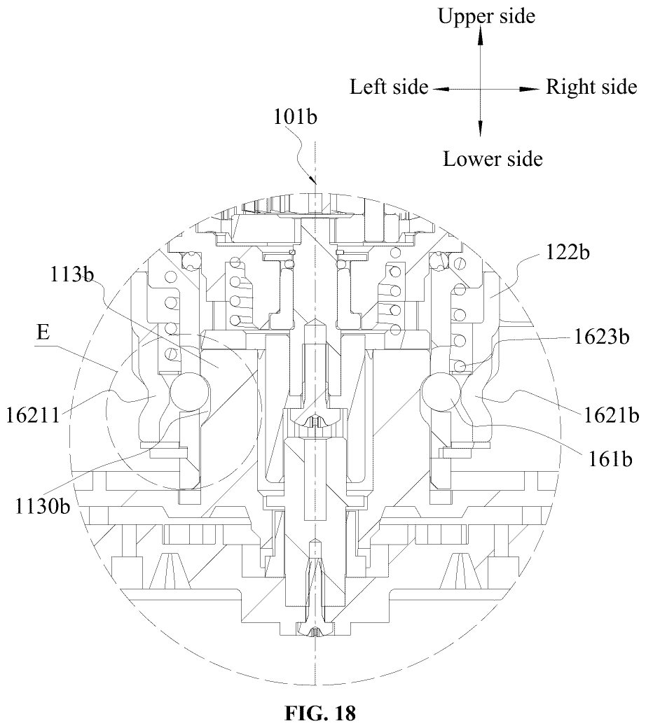

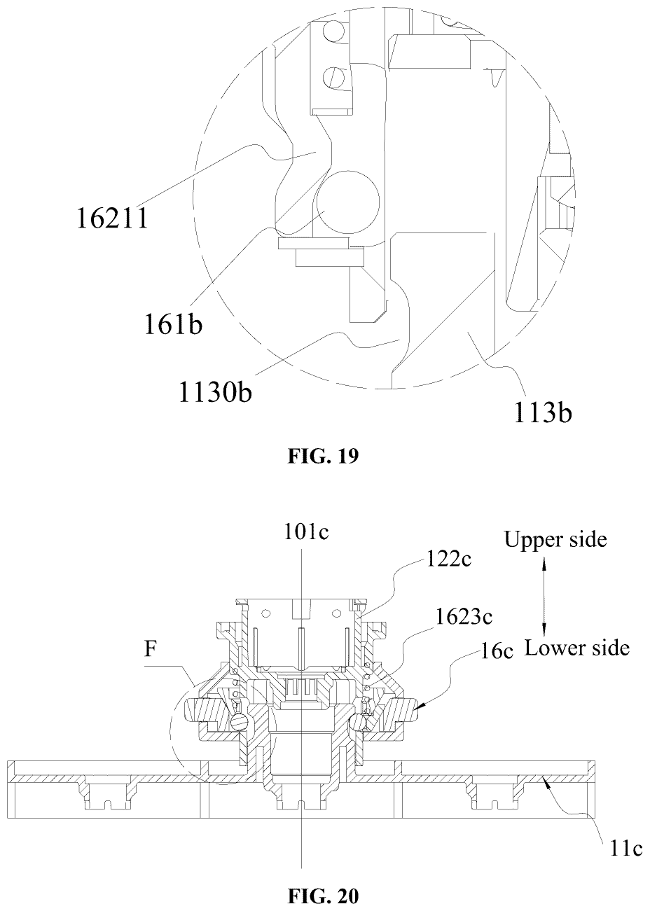

In this example, a first unlocking member 1621b includes an abutment portion 16211. The abutment portion 16211 may be configured as part of the inner wall surface of the device housing 122b that protrudes toward the first straight line 101b. As shown in FIGS. 17 and 18, in the state where the quick clamp is locked, a first elastic assembly 1623b applies a downward force to the abutment portion 16211 in the direction of the first straight line 101b to drive the abutment portion 16211 to press against a limit member 161b and cause the limit member 161b to enter a limit groove 1130b so that a mounting portion 113b is stuck. Thus, the movement of the mounting portion 113b in the direction of the first straight line 101 is limited. In this case, if an upward force along the direction of the first straight line 101b is applied to the device housing 122b and the force is sufficient to overcome the downward force applied to the abutment portion 16211 by the first elastic assembly 1623b, the device housing 122b can drive the abutment portion 16211 to move up along the direction of the first straight line 101b. When the abutment portion 16211 moves to the position where the abutment portion 16211 no longer presses against the limit member 161b, the limit member 161b can leave the limit groove 1130b and fall below the abutment portion 16211, and the quick clamp device enters the state where the quick clamp is unlocked shown in FIG. 19. In the state where the quick clamp is unlocked, the limit member 161b leaves the limit groove 1130b and is separated from the mounting portion 113b, and the mounting portion 113b is no longer stuck in the device housing 122b. Thus, the user can be allowed to operate the mounting portion 113b so that the mounting portion 113b moves in the direction of the first straight line 201.

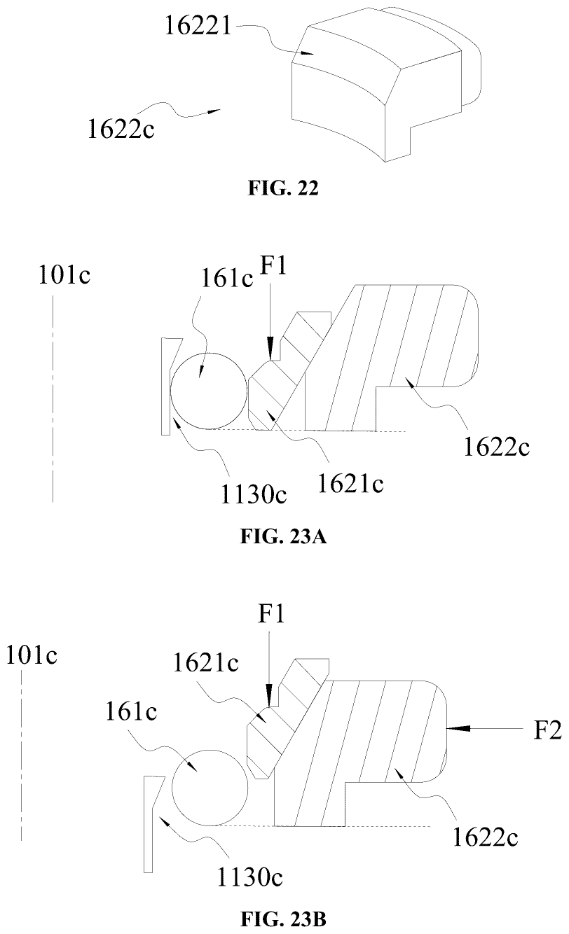

As shown in FIGS. 20 to 23, the present application provides a third type of quick clamp device 16c. In this example, the quick clamp device 16c includes a second unlocking member 1622c shown in FIG. 22. The second unlocking member 1622c moves in a direction perpendicular to a first straight line 101c to be capable of pushing a first unlocking member 1621c to move in the direction of the first straight line 101c.

The first unlocking member 1621c is configured as an independent object from a device housing 122c. The first unlocking member 1621c is provided with a step surface. The step surface can bear the downward force F1 applied by a first elastic assembly 1623c in the direction of the first straight line 101c. The second unlocking member 1622c may be a button shown in FIG. 22. The second unlocking member 1622c abuts against the first unlocking member 1621c, and the surface of the second unlocking member 1622c that abuts against and is in contact with the first unlocking member 1621c includes a bevel 3622a.

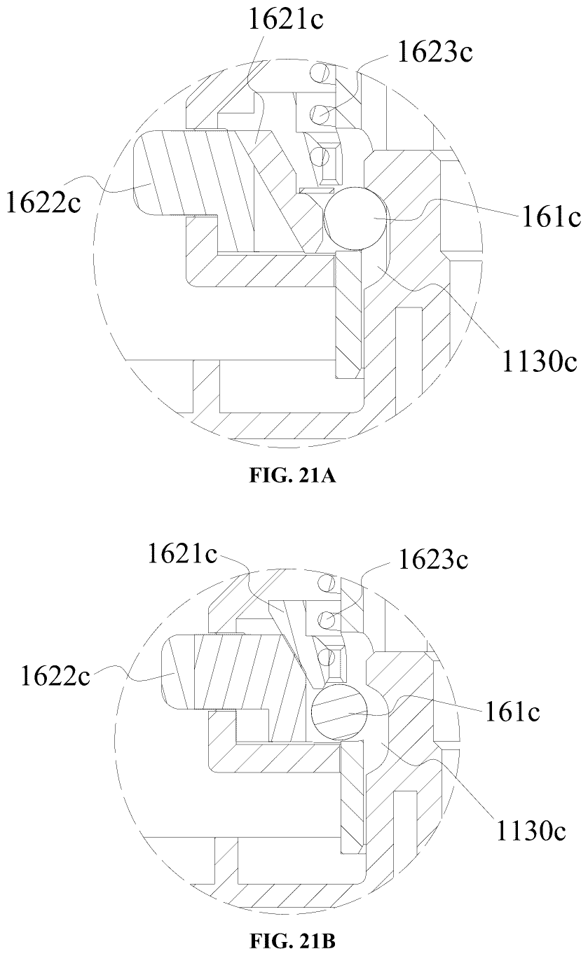

As shown in FIGS. 21A and 23A, in the state where the quick clamp is locked, the first unlocking member 1621c bears the downward force F1 applied by the first elastic assembly 1623c in the direction of the first straight line 101c, one end of the first unlocking member 1621c abuts against the bevel 3622a of the second unlocking member 1622c, and the other end of the first unlocking member 1621c abuts against a limit member 161c so that at least part of the limit member 161c enters a limit groove 1130c.

As shown in FIG. 21B and FIG. 23B, in the state where the quick clamp is unlocked, the second unlocking member 1622c is subjected to the action of a force F2. The force F2 may be applied by the user, and the direction of the force F2 is toward the limit member 161c in a direction perpendicular to the first straight line 101c. Under the action of the force F2, the second unlocking member 1622c moves toward the limit member 161c along the direction perpendicular to the first straight line 101c, and the bevel 16221 pushes the first unlocking member 1621c to move away from the limit member 161c. After the first unlocking member 1621c moves away from the limit member 161c, the wall surface of the limit groove 1130c that is in contact with the limit member 161c can push the limit member 161c to move away from the limit groove 1130c along the direction perpendicular to the first straight line 101c while the limit groove 1130c moves down along the direction of the first straight line 101c if the user moves a cleaning device 11c down. After the limit member 161c completely leaves the limit groove 1130c, at least part of the limit member 161c is located below the first unlocking member 1621c.

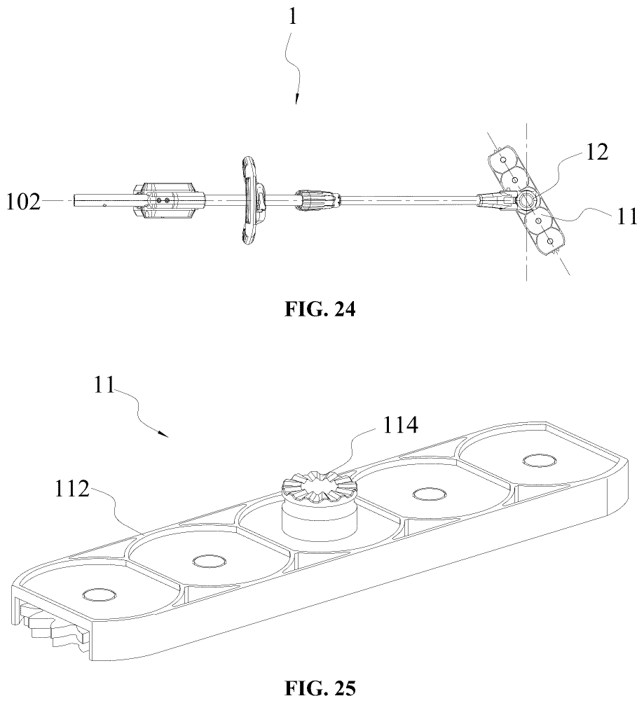

As shown in FIGS. 24 to 28, the power tool 1 further includes a rotary device 17. The rotary device 17 is disposed in the device housing 122 and can connect the cleaning device 11 to the driving device 12. The rotary device 17 includes a rotation-locked state and a rotation-unlocked state. In the rotation-locked state, the rotary device 17 forbids the cleaning device 11 from rotating. In the rotation-unlocked state, the rotary device 17 can allow the cleaning device 11 to rotate by using the first straight line 101 as a rotation axis. Thus, the user can rotate the cleaning device 11 to a desired angle in the rotation-unlocked state. When the user works, the rotary device 17 is switched to the rotation-locked state to meet a work requirement.

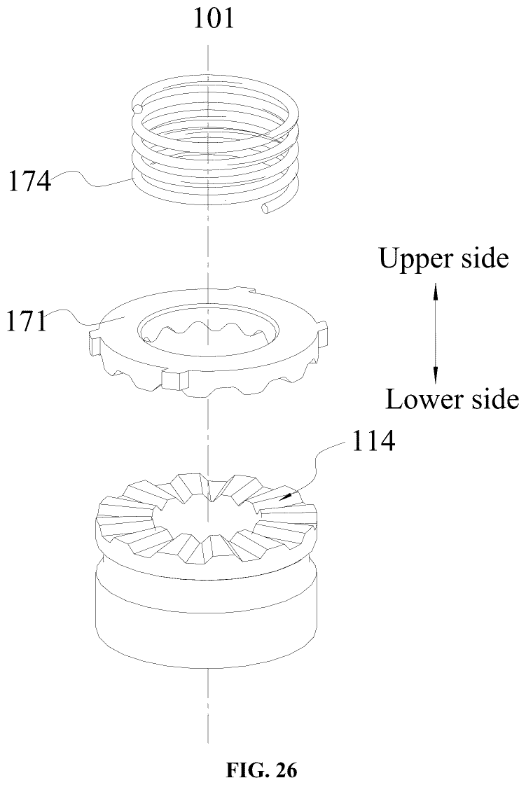

As shown in FIG. 26, in some examples, the rotary device 17 includes a first locking member 171 and a second elastic member 174. The cleaning device 11 includes a first mating portion 114. The first mating portion 114 can mesh with at least part of the first locking member 171. Optionally, the first mating portion 114 may be provided on the upper surface of the mounting portion 113. That is, the upper surface of the mounting portion 113 facing the driving device 12 is configured to have an uneven toothed disc shape. The lower surface of the first locking member 171 facing the cleaning device 11 is configured to have a toothed disc shape that can mesh with the first mating portion 114. The second elastic member 174 may be a spring and can press against the first locking member 171 down along the direction of the first straight line 101 so that the first locking member 171 meshes with the first mating portion 114. The first locking member 171 may be configured to have an annular structure. The upper surface of the first locking member 171 that is in contact with the second elastic member 174 may be configured as a plane, and the lower surface of the first locking member 171 that meshes with the first mating portion 114 may be configured to have an uneven toothed disc shape.

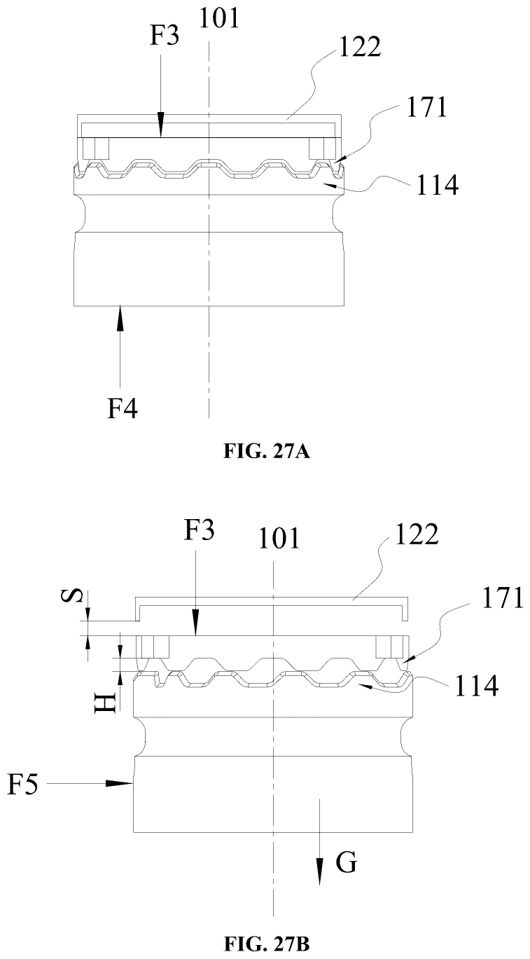

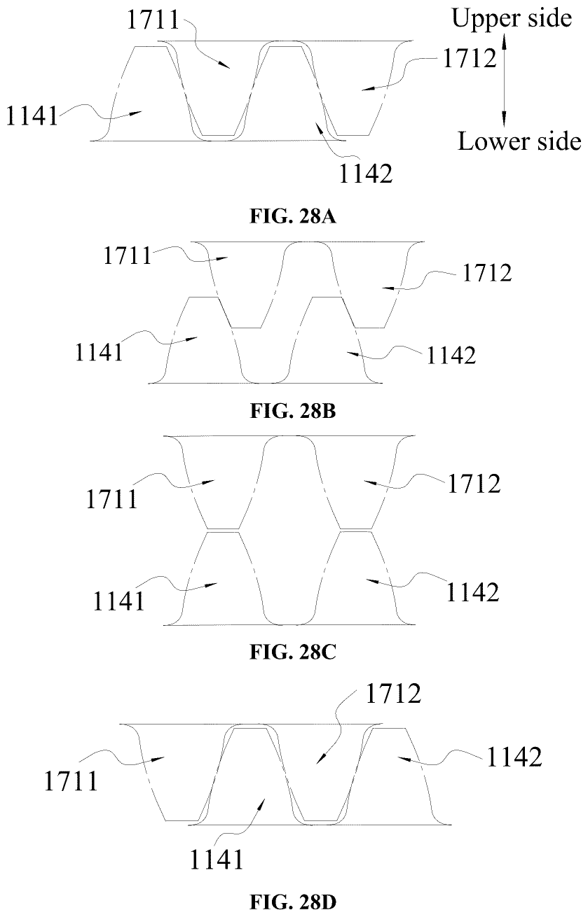

As shown in FIG. 27B, the user stops the cleaning work, the cleaning device 11 no longer bears a reaction force F4 from the floor, and thus, the rotary device 17 is switched to the rotation-unlocked state. After the force F4 is removed, the first mating portion 114 can move down a distance along the direction of the first straight line 101 under the action of gravity G. The first locking member 171 also moves down along the direction of the first straight line 101 under the action of the downward force F3 applied by the second elastic member 174 along the direction of the first straight line 101. A gap is generated between the first locking member 171 and the device housing 122 in the direction of the first straight line 101, and the first locking member 171 and the first mating portion 114 can be out of mesh. In this case, if the user applies a rotational force F5 to the first mating portion 114, the relative displacement of the teeth of the first mating portion 114 that mesh with the teeth of the first locking member 171 is caused. For the specific displacement process, reference may be made to FIG. 28. In the displacement process, the first locking member 171 moves up in the direction of the first straight line 101 due to the bevel between teeth. If the minimum distance S of the gap between the first locking member 171 and the device housing 122 in the direction of the first straight line 101 is less than the tooth depth H of the first mating portion 114 and the first locking member 171, the teeth of the first mating portion 114 cannot move to another position, and the relative displacement between the first locking member 171 and the first mating portion 114 stops. Therefore, in this example, the minimum distance S of the gap between the first locking member 171 and the device housing 122 in the direction of the first straight line 101 is greater than or equal to the tooth depth H of the first mating portion 114 and the first locking member 171 so that the first locking member 171 can move up in the direction of the first straight line 101.

When the cleaning device 11 accomplishes one rotation, a tooth of the first mating portion 114 and a tooth of the first locking member 171 are in a new relatively meshing position. In this case, the rotary device 17 is still in the rotation-unlocked state. If the user is not satisfied with this rotation angle of the cleaning device 11, the user may rotate the cleaning device 11 again to cause the tooth of the first mating portion 114 and the tooth of the first locking member 171 to be in another new relatively meshing position. When the user uses the power tool 1 to clean the floor, the cleaning device 11 bears the reaction force F4 from the floor. Under the action of the force F4, the cleaning device 11 moves up to a preset position along the direction of the first straight line 101, that is, the first locking member 171 tightly abuts against part of the inner wall of the device housing 122. In this case, the cleaning device 11 is located between the floor and the first locking member 171, and there is a lack of a movement gap or a movement distance in the direction of the first straight line 101. The teeth of the first mating portion 114 and the teeth of the first locking member 171 cannot accomplish the relative displacement. That is, the rotary device 17 is switched from the rotation-unlocked state to the rotation-locked state, and the cleaning device 11 cannot accomplish the rotation under the action of the reaction force F4 of the floor.

As shown in FIG. 27A, in the rotation-locked state, the upper surface of the first locking member 171 bears the downward force F3 applied by the second elastic member 174 along the direction of the first straight line 101, and the lower surface of the first locking member 171 meshes with the upper surface of the first mating portion 114 under the action of the force F3. In this case, if the user uses the power tool 1 to clean the floor, the cleaning device 11 bears the reaction force F4 from the floor, that is, the first mating portion 114 bears the upward force F4 along the direction of the first straight line 101. Thus, under the action of the forces F3 and F4, the first locking member 171 tightly meshes with the first mating portion 114. In addition, due to the action of the force F4, the first locking member 171 and the first mating portion 114 that mesh with each other move up along the direction of the first straight line 101 until the first locking member 171 is blocked by some parts of the inner wall of the device housing 122, and the first locking member 171 tightly abuts against the part of the inner wall of the device housing 122. In this case, the first locking member 171 and the first mating portion 114 cannot continue moving up along the direction of the first straight line 101. In summary, in the rotation-locked state, along the direction of the first straight line 101, the cleaning device 11 is located between the floor and the first locking member 171, and the first locking member 171 and the first mating portion 114 cannot accomplish a complete movement shown in FIG. 28 due to the lack of a sufficient movement gap or a sufficient movement distance. Therefore, the user cannot rotate the cleaning device 11 when the rotary device 17 is in the rotation-locked state. FIGS. 28A to 28D are schematic views showing the process where the relative displacement between the teeth of the first mating portion 114 and the teeth of the first locking member 171 is caused when the cleaning device 11 rotates. FIG. 28A shows the relative position between part of the first mating portion 114 and part of the first locking member 171 before the rotation of the cleaning device 11. FIG. 28B and FIG. 28C show the relative positions between the part of the first mating portion 114 and the part of the first locking member 171 during the rotation of the cleaning device 11. FIG. 28D shows the relative position between the part of the first mating portion 114 and the part of the first locking member 171 after the rotation of the cleaning device 11. It is defined that the first locking member 171 includes a first locking tooth 1711 and a second locking tooth 1712 and the first mating portion 114 includes a first mating tooth 1141 and a second mating tooth 1142.

As shown in FIG. 28A, the first mating portion 114 and the first locking member 171 mesh with each other, the first locking tooth 1711 is located between the first mating tooth 1141 and the second mating tooth 1142, and the second mating tooth 1142 is located between the first locking tooth 1711 and the second locking tooth 1712. As shown in FIG. 28B, when the cleaning device 11 starts rotating, the first mating portion 114 and the first locking member 171 are gradually separated from each other. As shown in FIG. 28C, the first mating portion 114 and the first locking member 171 are completely separated from each other, the first locking tooth 1711 leaves the gap between the first mating tooth 1141 and the second mating tooth 1142, and the second mating tooth 1142 leaves the gap between the first locking tooth 1711 and the second locking tooth 1712. As the cleaning device 11 continues rotating, the second locking tooth 1712 moves toward the gap between the first mating tooth 1141 and the second mating tooth 1142, and the first mating tooth 1141 starts entering the gap between the first locking tooth 1711 and the second locking tooth 1712. As shown in FIG. 28D, after the cleaning device 11 accomplishes one rotation, the second locking tooth 1712 is located between the first mating tooth 1141 and the second mating tooth 1142, and the first mating tooth 1141 is located between the first locking tooth 1711 and the second locking tooth 1712.

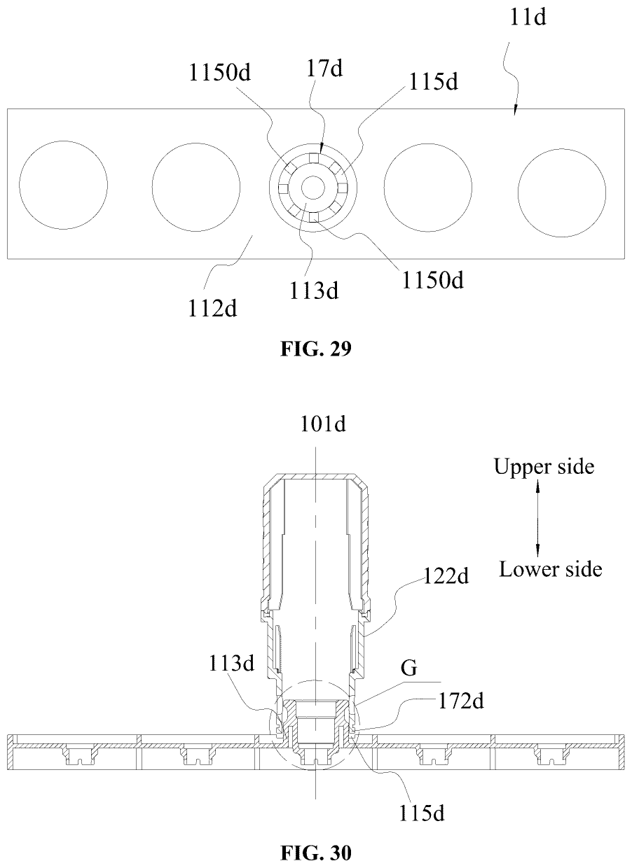

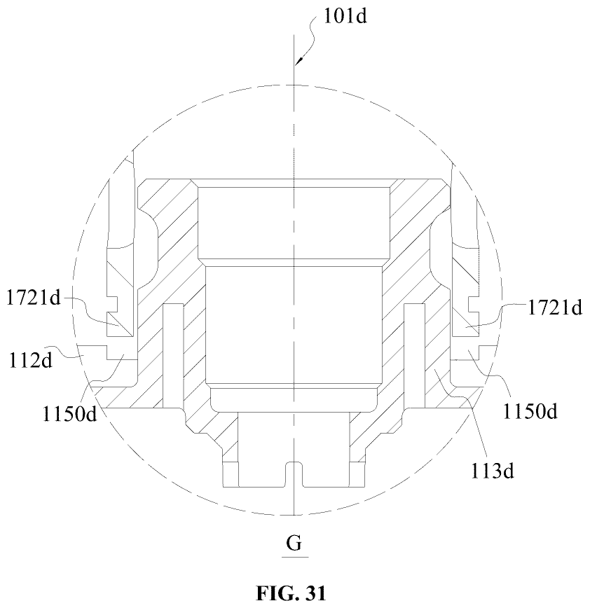

As shown in FIGS. 29 to 31, the present application provides a second type of rotary device 17d. The rotary device 17d includes a second locking member 172d. The second locking member 172d is provided at the lower end of a device housing 122d facing a cleaning device 11d. The cleaning device 11d includes a second mating portion 115d. The second mating portion 115d is connectable to at least part of the second locking member 172d through a snap. The second mating portion 115d is provided at the position where a mounting frame 112d is connected to a mounting portion 113d. Optionally, the second locking member 172d includes a protrusion portion 1721d, and the second mating portion 115d includes a slot portion 1150d matching the shape of the protrusion portion 1721d. For example, the second locking member 172d includes two protrusion portions 1721d, and the second mating portion 115d includes multiple slot portions 1150d symmetrically arranged. In the rotation-locked state, the second mating portion 115d is connected to the second locking member 172d through the snap. That is, the protrusion portions 1721d are inserted into slot portions 1150d, making it difficult for the cleaning device 11d to rotate. In the rotation-unlocked state, the second mating portion 115d is separated from the second locking member 172d. That is, the protrusion portions 1721d can leave slot portions 1150d so that the cleaning device 11d can rotate. For example, the protrusion portions 1721d can leave a pair of slot portions 1150d and then be inserted into another pair of slot portions 1150d.

If the user uses the power tool to clean the floor, the cleaning device 11d bears a reaction force from the floor. The mounting frame 112d and the mounting portion 113d drive the second mating portion 115d to move up relative to the device housing 122d along the direction of a first straight line 101d. In this manner, at least part of each of the protrusion portions 1721d of the second locking member 172d enters a slot portion 1150d. Thus, the slot portions 1150d can limit the movement of the second locking member 172d in the front and rear direction and the left and right direction, that is, the rotary device 17d enters the rotation-locked state.

If the user stops using the power tool to clean the floor, the user no longer applies pressure to the cleaning device 11d through the device housing 122d to make the cleaning device 11d bear the force from the floor. That is, the protrusion portions 1721d can leave the slot portions 1150d, and the rotary device 17d enters the rotation-unlocked state. In the rotation-unlocked state, after the protrusion portions 1721d leave a pair of slot portions 1150d, the cleaning device 11d can rotate. That is, the relative position between the second mating portion 115d and the second locking member 172d changes, and after the cleaning device 11d rotates a certain angle, the protrusion portions 1721d can be inserted into another pair of slot portions 1150d.

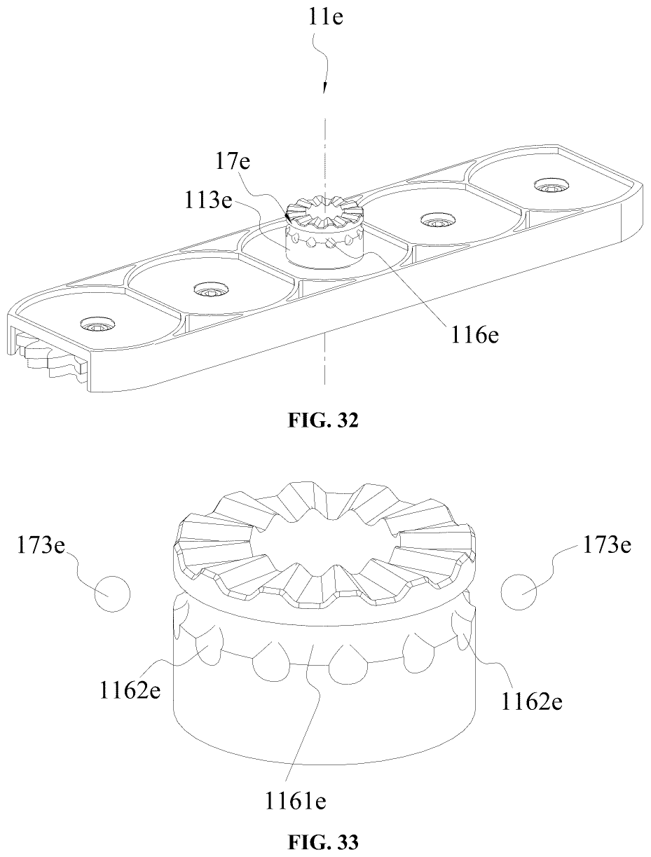

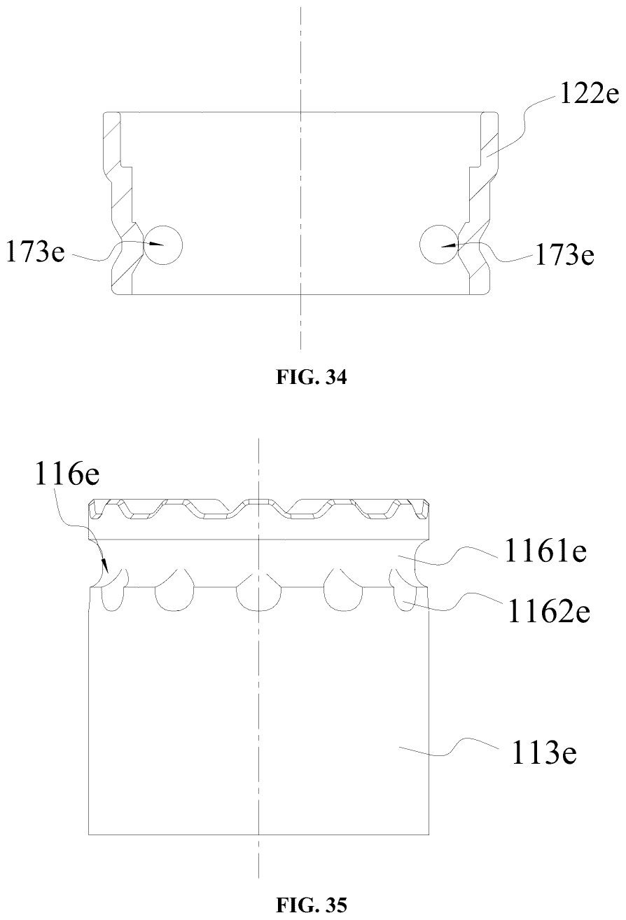

As shown in FIGS. 32 to 36, the present application provides a third type of rotary device 17e. The rotary device 17e includes a third locking member 173e. The third locking member 173e is configured as a sphere. Optionally, the third locking member 173e may be the limit member 161 of the quick clamp device 16. That is, the limit member 161 of the quick clamp device 16 may also be used as the third locking member 173e of the rotary device 17e. As shown in FIGS. 32 and 33, a cleaning device 11e includes a third mating portion 116e provided at the intermediate section of a mounting portion 113e. The third mating portion 116e includes a first groove 1161e and multiple second slots 1162e. The first groove 1161e communicates with the multiple second slots 1162e, and the dimension of each of the multiple second slots 1162e matches the dimension of the third locking member 173e. Optionally, the first groove 1161e may be the limit groove 1130 for mating with the limit member 161 of the quick clamp device 16. That is, the limit groove 1130 may also be used as the first groove 1161e of the third mating portion 116e.

In the rotation-locked state, if the user uses the power tool to clean the floor in this case, part of the inner wall of the device housing presses against the third locking member 173e so that the third locking member 173e is accommodated in a second slot 1162e, and the third locking member 173e cannot leave the second slot 1162e due to being blocked by the part of the inner wall of the device housing. In some examples, the part of the inner wall of the device housing that presses against the third locking member 173e may be the first unlocking member 1621b of the quick clamp device 16b. Specifically, the part of the inner wall of the device housing may be the abutment portion 16211.

In the rotation-unlocked state, if the user stops the cleaning work, the cleaning device 11e no longer bears a reaction force from the floor. After the force is removed, the mounting portion 113e can drive the third mating portion 116e to move down a distance along the direction of a first straight line 101e under the action of the gravity G. In this case, the third locking member 173e leaves the second slot 1162e and can move in the first groove 1161e. After the cleaning device 11e rotates a certain angle, the third locking member 173e can stop at a position above another second slot 1162e in the first groove 1161e. In this case, if the cleaning device 11e is pressed through the device housing to bear the force from the floor, the cleaning device 11e bears an upward force along the direction of the first straight line 101e. In this manner, the third mating portion 116e moves up, and the third locking member 173e moves from the first groove 1161e to the second slot 1162e under the action of the part of the inner wall of the device housing and the third mating portion 116e.

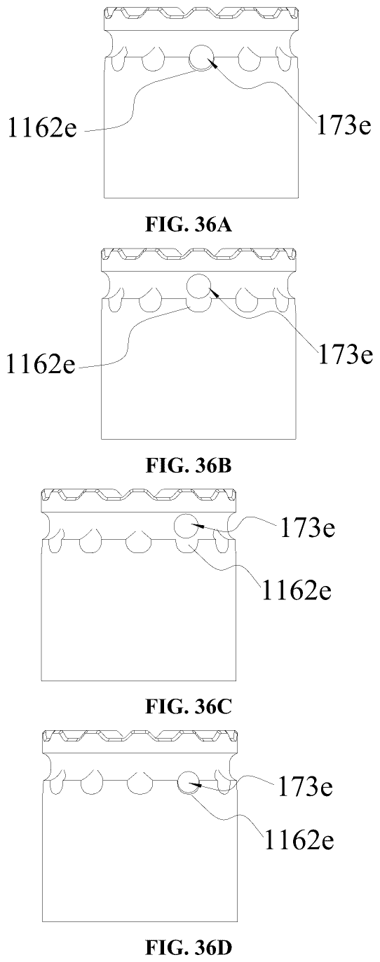

FIGS. 36A to 36D are schematic views showing the process where the third locking member 173e moves in the third mating portion 116e when the cleaning device 11e rotates. FIG. 36A shows the relative position between a single third locking member 173e and the third mating portion 116e before the rotation of the cleaning device 11e, that is, in the rotation-locked state. FIGS. 36B and 36C show the relative positions between part of the third mating portion 116e and the single third locking member 173e during the rotation of the cleaning device 11e. FIG. 36D shows the relative position between the part of the third mating portion 116e and the single third locking member 173e after the rotation of the cleaning device 11e, that is, in a new rotation-locked state.

As shown in FIG. 36A, the rotary device 17e is in the rotation-locked state, and the third locking member 173e is accommodated in one second slot 1162e in this case. When the cleaning device 11e starts rotating, as shown in FIGS. 36B and 36C, the third locking member 173e first leaves the second slot 1162e and enters the first groove 1161e and then moves in the first groove 1161e until the third locking member 173e reaches a position above another second slot 1162e. Thereafter, as shown in FIG. 36D, the rotary device 17e is switched to the new rotation-locked state, and the third locking member 173e is accommodated in the second slot 1162e.

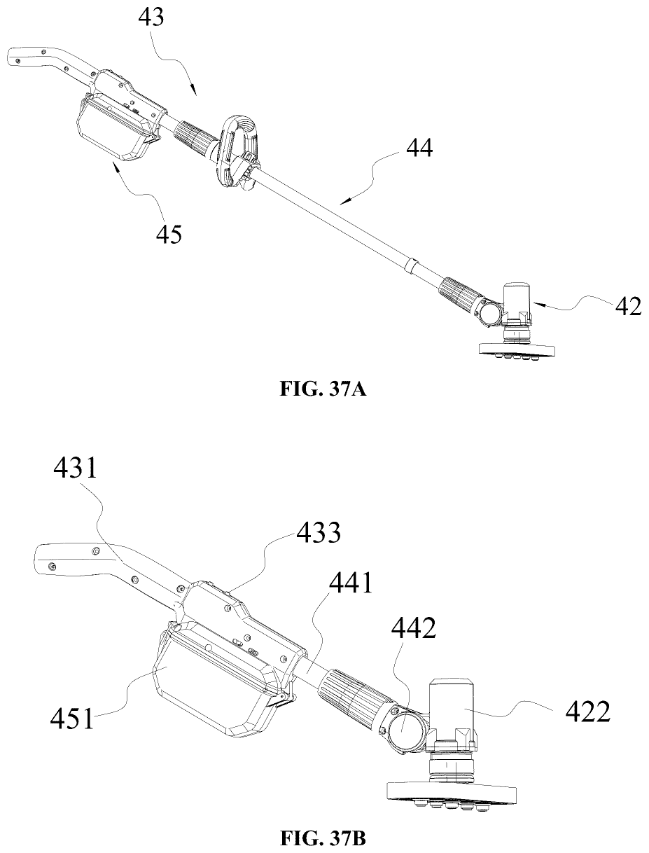

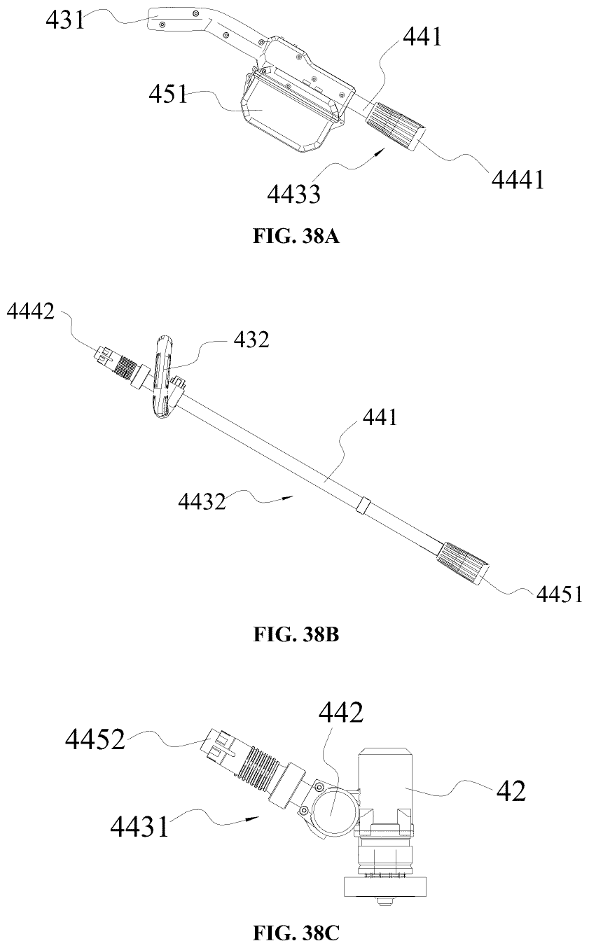

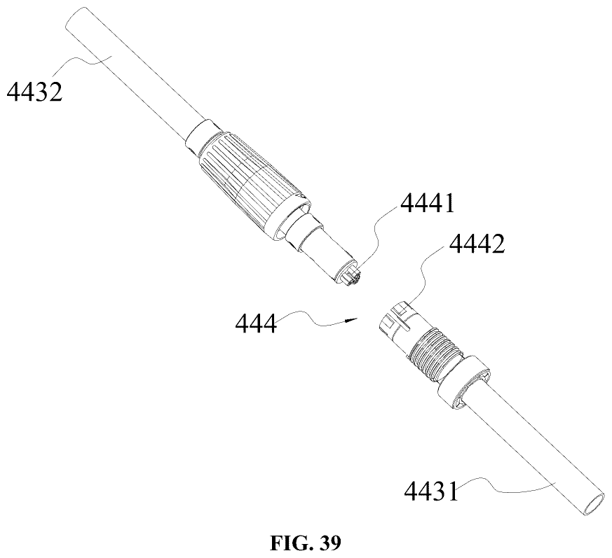

As shown in FIGS. 37 to 39, the present application provides a connecting device 44 that can be assembled and spliced. The connecting device 44 includes a first connecting device 4431 and a second connecting device 4432. One end of the first connecting device 4431 is connected to a driving device 42, and the other end of the first connecting device 4431 is connected to the second connecting device 4432. One end of the second connecting device 4432 is connected to the first connecting device 4431, and the other end of the second connecting device 4432 is connected to an operation device 43.

The connecting device 44 further includes a first electrical plug-in connector assembly 444, and the first connecting device 4431 and the second connecting device 4432 are electrically connected to each other through the first electrical plug-in connector assembly 444. The first electrical plug-in connector assembly 444 includes a first plug 4441 and a first socket 4442. The first electrical plug-in connector assembly 444 is in the on state when the first plug 4441 is inserted into the first socket 4442, and the user can operate the driving device 42 through a switch assembly 433 of the operation device 43. The first electrical plug-in connector assembly 444 is in the off state when the first plug 4441 is removed from the first socket 4442. Optionally, the first plug 4441 is disposed at an end of the second connecting device 4432, and the first socket 4442 is disposed at the end of the first connecting device 4431 connected to the second connecting device 4432, or the first plug 4441 is disposed at an end of the first connecting device 4431, and the first socket 4442 is disposed at the end of the second connecting device 4432 connected to the first connecting device 4431.

In some examples, the connecting device 44 further includes a third connecting device 4433 detachably connected to the second connecting device 4432. One end of the third connecting device 4433 is connected to the second connecting device 4432, and the other end of the third connecting device 4433 is connected to a main handle 431. The second connecting device 4432 is connected to an auxiliary handle 432.

The connecting device 44 further includes a second electrical plug-in connector assembly, and the third connecting device 4433 and the second connecting device 4432 are electrically connected to each other through the second electrical plug-in connector assembly. The second electrical plug-in connector assembly includes a second plug and a second socket. The second electrical plug-in connector assembly is in the on state when the second plug is inserted into the second socket, and the user can operate the driving device 42 through the switch assembly 433 of the operation device 43. The second electrical plug-in connector assembly is in the off state when the second plug is removed from the second socket. Optionally, the second plug is disposed at an end of the second connecting device, and the second socket is disposed at the end of the third connecting device 4433 connected to the second connecting device 4432, or the second plug is disposed at an end of the third connecting device 4433, and the second socket is disposed at the end of the second connecting device 4432 connected to the third connecting device 4433.

In some examples, the first connecting device 4431 includes a hinge assembly 442. The hinge assembly 442 is connected to the driving device 42. The second connecting device 4432 includes part of a connecting rod 441 and is connected to the auxiliary handle 432. The third connecting device 4433 includes the remaining part of the connecting rod 441 and is connected to the main handle 431 and a power supply housing 451. The power supply housing 451 is disposed between the main handle 431 and the second connecting device 4432. Specifically, the power supply housing 451 is disposed between the main handle 431 and the auxiliary handle 432.

In some examples, each of the first electrical plug-in connector assembly 444 and the second electrical plug-in connector assembly is further provided with a sealing ring (not shown in the figure), such as an O-ring, to achieve waterproof and dustproof effects.

In this example, the user may choose to detach the second connecting device 4432 and mount the third connecting device 4433 connected to the power supply housing 451 to the first connecting device 4431 connected to the driving device 42, thereby changing the long connecting device 44 shown in FIG. 37A to the short connecting device 44 shown in FIG. 37B. In addition, to ensure the transmission of an electrical signal and power, the second plug of the third connecting device 4433 may be electrically connected to the first socket 4442 of the first connecting device 4431, or the second socket of the third connecting device 4433 may be electrically connected to the first plug of the first connecting device 4431. Thus, the user is allowed to be capable of operating the driving device 42 through the switch assembly 433 of the operation device 43.

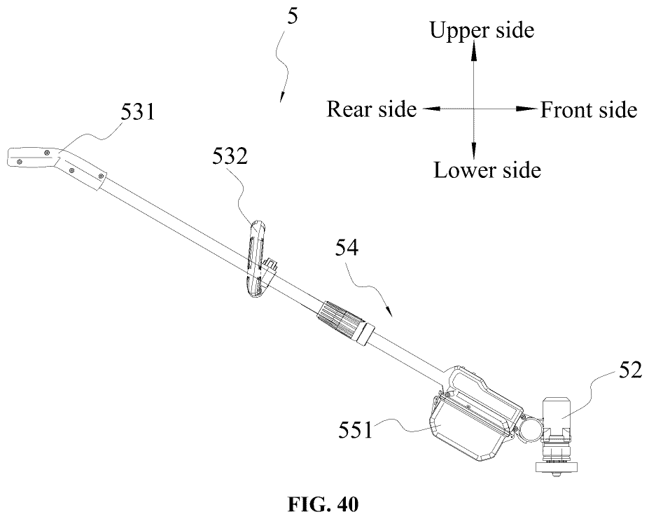

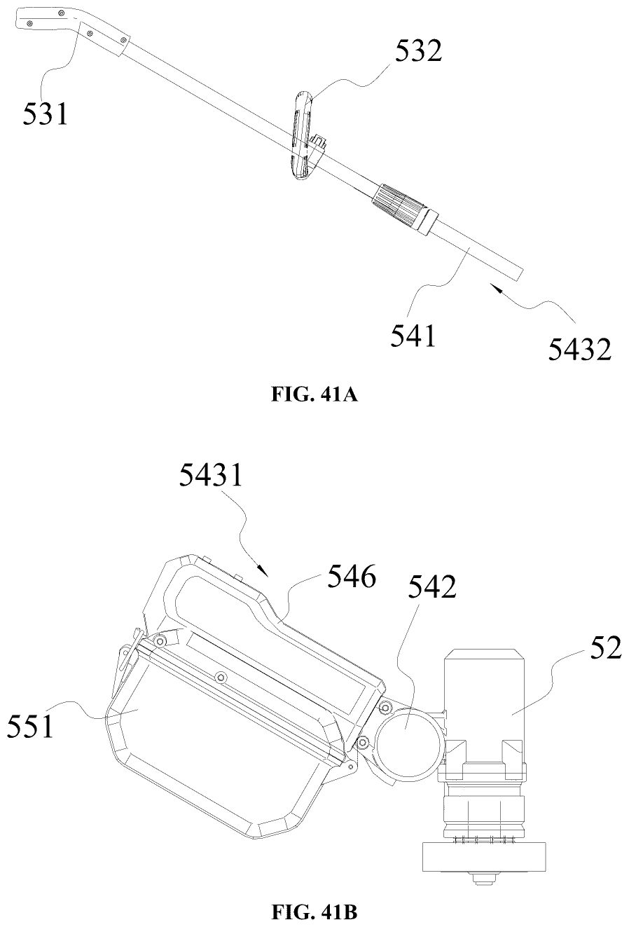

As shown in FIGS. 40 and 41, the present application further provides a connecting device 54 that can be assembled and spliced. The connecting device 54 includes a first connecting device 5431 and a second connecting device 5432. The first connecting device 5431 includes a hinge assembly 542, and the hinge assembly 542 is connected to a driving device 52. The second connecting device 5432 includes a connecting rod 541 and connects a main handle 531 to an auxiliary handle 532. The first connecting device 5431 is connected to a power supply housing 551, and the power supply housing 551 is disposed between the hinge assembly 541 and the second connecting device 5432. Specifically, the power supply housing 551 is disposed between the hinge assembly 541 and the auxiliary handle 532. In this example, the user is allowed to continue to use a power tool 5 after the second connecting device 5432 is detached. In some examples, the first connecting device 5431 further includes a handle 546. One end of the handle 546 is connected to the hinge assembly 542, and the other end of the handle 546 can be connected to the connecting rod 541. The handle 546 is disposed on the power supply housing 551. The user can hold the handle 546 to use the power tool 5 after detaching the second connecting device 5432.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application. Moreover, it is also to be noted that compatible portions in different examples of the present application are each applicable to other examples, for example, the quick clamp device 16, the quick clamp device 16b, and the quick clamp device 16c, and the rotary device 17, the rotary device 17d, and the rotary device 17e provided in the present application. On the premise that the technical solutions are not contradictory, the quick clamp device 16 may also be combined with and match the rotary device 17d or the rotary device 17e, instead of being capable of matching only the rotary device 17.

What is claimed is:

1. A power tool for cleaning, comprising:
a cleaning device comprising a working accessory for cleaning;
a driving device comprising a motor for driving the working accessory to rotate, wherein the motor comprises a motor shaft rotating about a first straight line;
an operation device for a user to operate so as to control the power tool;
a power supply device for supplying power to the driving device; and
a connecting device for connecting the driving device to the operation device;
wherein the operation device comprises a main handle for the user to hold, and the power supply device is disposed between the main handle and the driving device.

2. The power tool according to claim 1, wherein the power supply device comprises a power supply housing for accommodating a battery pack, and the power supply housing is disposed between the main handle and the driving device.

3. The power tool according to claim 2, wherein the operation device further comprises an auxiliary handle for cooperating with the main handle to allow the user to hold the main handle and the auxiliary handle with both hands, and the power supply housing is disposed between the main handle and the auxiliary handle.

4. The power tool according to claim 3, wherein the auxiliary handle is configured to be annular or U-shaped.

5. The power tool according to claim 2, wherein the connecting device further comprises an auxiliary grip for cooperating with the main handle to allow the user to hold the main handle and the auxiliary grip with both hands, and the power supply housing is disposed between the main handle and the auxiliary grip.

6. The power tool according to claim 1, wherein the connecting device extends along a direction of a second straight line, the main handle comprises a first grip provided at an end of the main handle facing the power supply housing and a second grip provided at an end of the main handle away from the power supply housing, the first grip extends along the direction of the second straight line, and an extension direction of the second grip is inclined with respect to the second straight line.

7. The power tool according to claim 6, wherein an included angle formed between the extension direction of the second grip and the second straight line is greater than or equal to 5° and less than or equal to 50°.

8. The power tool according to claim 2, wherein the power supply device comprises the battery pack, the battery pack is configured to provide a direct current power supply for the motor, the power supply housing comprises an accommodation compartment for accommodating the battery pack, the connecting device extends along a direction of a second straight line, and the battery pack enters the accommodation compartment along a direction parallel to or inclined with respect to the direction of the second straight line.

9. The power tool according to claim 1, wherein the operation device further comprises a switch assembly capable of controlling the driving device to start or stop, and the switch assembly is disposed opposite to a power supply housing.

10. The power tool according to claim 1, wherein the power supply device comprises a battery pack configured to provide a direct current power supply for the motor, and a voltage of the battery pack is one of 12 V, 18 V, 24 V, 36 V, and 56 V.

11. The power tool according to claim 1, wherein the power supply device comprises a battery pack configured to provide a direct current power supply for the motor and a power supply housing for accommodating the battery pack, and the power supply housing comprises an accommodation compartment for accommodating the battery pack.

12. The power tool according to claim 11, wherein the accommodation compartment comprises a first compartment body forming a cavity for accommodating the battery pack and a second compartment body for covering an opening leading to the cavity.

13. The power tool according to claim 11, wherein the accommodation compartment is disposed under the operation device.

14. The power tool according to claim 1, wherein the motor has a rotational speed of 12000 to 25000 revolutions per minute.

15. The power tool according to claim 1, wherein the working accessory has a rotational speed of 250 to 600 revolutions per minute.

16. The power tool according to claim 1, wherein the connecting device comprises a telescopic rod, the telescopic rod is moveable to an extended state and a retracted state, and a ratio of a length of the telescopic rod in the retracted state to a length of the telescopic rod in the extended state is 0.4 to 0.8.

17. The power tool according to claim 1, wherein the power tool comprises a tool body, the tool body comprises the cleaning device, the driving device, the operation device, and the connecting device, and the tool body has a weight of 1.5 kilograms to 3 kilograms.

18. The power tool according to claim 17, wherein the tool body has a length of 50 centimeters to 150 centimeters.

19. The power tool according to claim 17, wherein a center of gravity of the tool body is between the driving device and the operation device.

20. A power tool for cleaning, comprising:
a cleaning device comprising a working accessory for cleaning;
a driving device comprising a motor for driving the working accessory to rotate, wherein the motor comprises a motor shaft rotating about a first straight line;
an operation device for a user to operate so as to control the power tool;
a power supply device for supplying power to the driving device; and
a connecting device for connecting the driving device to the operation device;
wherein the operation device comprises a main handle for the user to hold and an auxiliary handle for cooperating with the main handle to allow the user to hold the main handle and the auxiliary handle with both hands, and the power supply device is disposed between the main handle and the auxiliary handle.
